(19) United States
(12) Patent Application Publication
(10) Pub. No.: US 2008/0172243 A1
(43) Pub. Date: Jul. 17, 2008

(54) SYSTEM AND METHOD FOR PROVIDING TARGETED, INTERACTIVE, MULTIMEDIA CONTENT FOR ENTERTAINING, ADVERTISING, AND PROMOTIONAL PURPOSES

(76) Inventor: Michael J. Kelly, Merrimack, NH (US)

Correspondence Address: Michael R. Reinemann;Cesari & McKenna, LLP, 88 Black Falcon Avenue, Boston, MA, 02210, US

(21) Appl. No.: 11/753,267

(22) Filed: May 24, 2007

Related U.S. Application Data
(63) Continuation-in-part of application No. 11/622,063, filed on Jan. 11, 2007.

(51) Int. Cl. G06Q 30/00; G06F 3/041

(52) U.S. Cl. 705/1; 345/173

(57) ABSTRACT

A system and method provides content to a plurality of kiosks located in establishments for playback at those establishments. The system includes a management server that controls the delivery of the content to the kiosks, and schedules the playback of the content. The kiosks have one or more display screens for playing back the content. The kiosks receive information from the patrons at the establishments and pass this information to the management server. Based on the information collected by the kiosks, targeted content is provided to the kiosks by the management server.

### CROSS-REFERENCE TO RELATED APPLICATIONS

The present application is a continuation-in-part of commonly assigned copending U.S. patent application Ser. No. 11/622,063, which was filed on Jan. 11, 2007, by Michael J. Kelly for a System and Method for Providing Targeted, Interactive, Multi-Media Content for Entertaining, Advertising and Promotional Purposes and is hereby incorporated by reference in its entirety.

### FIELD OF THE INVENTION

The present invention relates generally to advertising systems and, more specifically, to a system and method for providing content to a location and collecting customer data, and a business method for implementing the same.

### BACKGROUND OF THE INVENTION

Advertising is essential for marketing goods and services, attracting customer patronage, or otherwise communicating a commercial or political message to a widespread audience. Indeed, consumers are inundated with advertisements every day. The advertisements are typically presented through various types of media including, but not limited to, television, radio, print, billboard (or other outdoor signage), Internet, digital signage, cellular screens, etc. Most often, advertisements are presented to the general public, with the hope that they will catch the attention of prospective customers and induce those customers to purchase the advertised goods or services. However, as a consequence, conventional mass advertising suffers the disadvantage of inconveniencing those consumers who are not within the scope of the intended audiences. Moreover, if an advertisement does not attract the attention of a large enough segment of its intended audience, the cost of creating and disseminating the advertisement may significantly outweigh its effectiveness.

In recognition of these inefficiencies, techniques have been employed to help “target” advertisements to their relevant customer bases. Typically, the advertisements are strategically placed and/or scheduled to attract predominantly the attention of a desired customer demographic. In some cases, the demographic may be identified based on sales statistics collected at particular points of purchase. For example, a retail outlet may determine that it sells more products in its “Womens” department than in its “Mens.” As such, the outlet may target the majority of its in-store advertisements for products traditionally appealing to women. In other cases, the customer demographic may be determined based on survey data, such as data published by the U.S. Census Bureau, or statistics acquired by a polling company, such as the Gallup® Organization or Nielsen Media Research®.

While targeted advertisements can be more effective than mass advertisements, conventional targeted-advertising systems are currently limited in their ability to home in on their desired audiences. First, targeted-advertising systems typically identify customer demographics based on insufficient or out-dated customer data. Customer shopping habits tend to be dynamic, and often are not accurately represented by past statistics. For instance, U.S. Census statistics are measured every ten years, and therefore may become out-of-date as compared with current conditions. Likewise, previously-acquired polling information also may become quickly dated, e.g., as retail trends change from season to season. Therefore, reliance on conventional statistical indicators does not give a “real-time” view of the customer demographics being targeted. In addition, the relied-on indicators also may not correspond exactly to specific points of purchase targeted by the advertisers.

The cost of implementing a conventional targeted-advertising system can also be prohibitive.

### SUMMARY OF THE INVENTION

Briefly, in the illustrative embodiment, the present invention relates to a system and method for delivering and displaying content, such as advertisements, at selected locations, and for collecting information from people, such as customers and patrons, at those locations. The system preferably includes a management server in communicating relationship with a plurality of interactive kiosks through a private network. The management server is also in communicating relationship with one or more servers, and can access the Internet. Each interactive kiosk is preferably located at a place of public accommodation, a private establishment or other place frequented by patrons or customers. The management server controls the delivery of content to the kiosks, and schedules its display at the kiosk. The patrons or customers interact with the kiosks by selecting music to be played, performing karaoke, playing electronic games, and entering contests, among other things. The interactive kiosks collect information from the patrons or customers, as well as information concerning how the patrons and customers use the kiosks, such as what music is played, what promotions or contests are entered, etc. This information is forwarded to and collected by the management server. The management server includes a data collection facility that can be operated by a system administrator to review the collected information, and to generate reports indicating the demographics and purchasing preferences of the patrons or customers at the establishments at which the kiosks are located. This information can then be used to target and schedule specific content, such as advertisements or promotions, to particular kiosks.

In a further embodiment, the system includes a telephony gateway in communicating relationship with the management server. By virtue of the telephony gateway, patrons or customers can interact with the system through other devices, besides the kiosks, such as cell phones, smart phones, personal digital assistants (PDAs), etc. The patrons can also use these devices to interact with the kiosks. Patrons may also interact with the system through devices, such as personal computers, connected to the Internet.

In yet a further embodiment, the system supports the creation and operation of a web-based social network. Individuals can register with the social network, create profiles of themselves and search for other network members who share similar interests. In the preferred embodiment, the social network is organized around the establishments at which interactive kiosks are located. That is, members preferably associate themselves with one or more such establishments. Network members can obtain information about events taking place at those establishments and participate in such events. Network members can also search the social network to find establishments that may be of interest to them based on the type of establishment and/or the entertainment offered at the establishment, among other things.

### BRIEF DESCRIPTION OF THE DRAWINGS

The above and further advantages of the invention may be better understood by referring to the following description in conjunction with the accompanying drawings in which like reference numerals indicate identically or functionally similar elements, of which:

FIG. 1 is a schematic block diagram of an exemplary targeted-advertising system in accordance with an illustrative embodiment of the present invention;

FIG. 2 is a schematic block diagram of an illustrative data-collection device that may be deployed in the targeted-advertising system of FIG. 1;

FIG. 3 is a schematic block diagram of an illustrative central management server that may be deployed in the targeted-advertising system of FIG. 1;

FIG. 4 is a flowchart illustrating a sequence of steps for delivering targeted advertising to a point of purchase in accordance with the illustrative embodiment;

FIG. 5A is a schematic block diagram of a prior technique for distributing products and advertisements from a brand advertiser to a point of purchase;

FIG. 5B is a schematic block diagram of a new technique for distributing products and advertisements that advantageously may be used in accordance with the illustrative embodiments of the present invention;

FIG. 6 is a flowchart illustrating a sequence of steps for implementing a method for delivering targeted advertising to a point of purchase in accordance with an illustrative embodiment of the present invention;

FIG. 7 is a highly schematic illustration of a system for providing content management and delivery, and supporting a social network in accordance with a preferred embodiment of the present invention;

FIG. 8 is a highly schematic, functional block diagram of a preferred embodiment of a management server of the system of FIG. 7;

FIGS. 9-11 are highly schematic illustrations of preferred embodiments of a kiosk of the system of FIG. 7;

FIGS. 12-17 are highly schematic illustrations of touch screen displays of a kiosk; and

FIGS. 18-25 are highly schematic illustrations of web pages supporting a social network in accordance with a preferred embodiment of the present invention.

### DETAILED DESCRIPTION OF ILLUSTRATIVE EMBODIMENTS

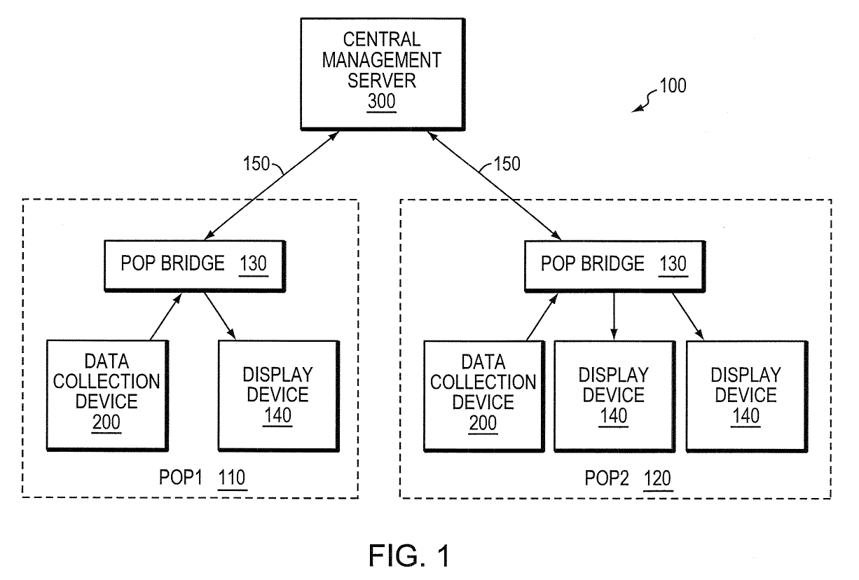

FIG. 1 illustrates an exemplary targeted-advertising system 100 in accordance with an illustrative embodiment of the invention. The advertising system includes a central management server 300 coupled to one or more points of purchase (POP), such as POP1 110 and POP2 120. Each point of purchase includes a POP bridge 130, at least one data-collection device 200 and at least one display device 140. As used herein, a point of purchase is not limited to a commercial establishment, and is defined as any location where potential customers can interact with the data-collection and display devices. For instance, points of purchase may include, inter alia, retail outlets, restaurants, bars, sports arenas, convention centers, building lobbies, public or private walkways, etc.

Each POP bridge 130 is connected to the central management server 300 by a respective data and/or control link 150. Preferably, the link 150 is a bi-directional connection that is dedicated for transmitting and receiving communications between the server 300 and the bridge 130. To that end, the link 150 may be a leased line or other private connection that protects network traffic within the targeted-advertising system 100 from being accessed by unauthorized users or devices. In a preferred embodiment, any routers, switches or other intervening networking equipment (not shown) are also configured to exclude external network traffic. The data and/or control link 150 physically may comprise one or more individual connections between the server and the bridge. For example, the link 150 may be implemented as a pair of opposing uni-directional links, which collectively function as a single bi-directional link. Further, the link 150 may be established over various physical mediums, such as conventional wire links, optical links, wireless links, etc., and may communicate data and control information using various communication protocols.

The POP bridge 130 primarily formats and coordinates data flows between the central management server 300 and the data-collection and display devices. In operation, customers at a point of purchase, such as POP1 or POP2, interact with a data-collection device 200 to input selected personal data, e.g., in response to an enter-to-win (ETW) promotion, customer survey, cross-promotion, etc. The customer data is forwarded from the data-collection device to the POP bridge 130. The data may be sent unencrypted in certain cases, although sensitive information, such as credit card numbers or social security numbers, may be encrypted by the data-collection device before being forwarded. Yet other embodiments may encrypt all communications between the bridge and the central management server. The POP bridge receives the customer data and, if necessary, reformats the data for forwarding to the central management server. The bridge also may add supplemental information, such as headers identifying the bridge and/or the point of purchase, before transmitting the customer-entered data.

The central management server 300 receives the customer data from the POP bridge 130. Preferably, the server aggregates the received data with other customer data (if any) previously received from the same point of purchase. Then, the server performs statistical analyses on the aggregated data to select a set of digital advertisements to return to the point of purchase. The server transmits the selected advertisements, preferably together with scheduling information, to the POP bridge 130. The bridge receives the advertisements and reformats them if necessary. The bridge forwards the advertisements to one or more display devices, which, in turn, present the advertisements to customers at the point of purchase. In a preferred embodiment, the display devices 140 also may display “call to action” items/ads which direct targeted customers to go to the data-collection device 200 and use the system.

Illustratively, the POP bridge 130 may be a general-purpose or special-purpose computer configured to perform the above-noted functions. Preferably, the display device 140 is a conventional television display, such as a plasma or LCD television. Accordingly, the POP bridge may be configured to schedule a predetermined order and timing for which targeted advertisements are presented by each of the display devices 140. Moreover, in the event that the data-collection device 200 is implemented as a “dummy” terminal, i.e., with minimal on-board processing, the POP bridge 130 also may control the display and operations at the data-collection device.

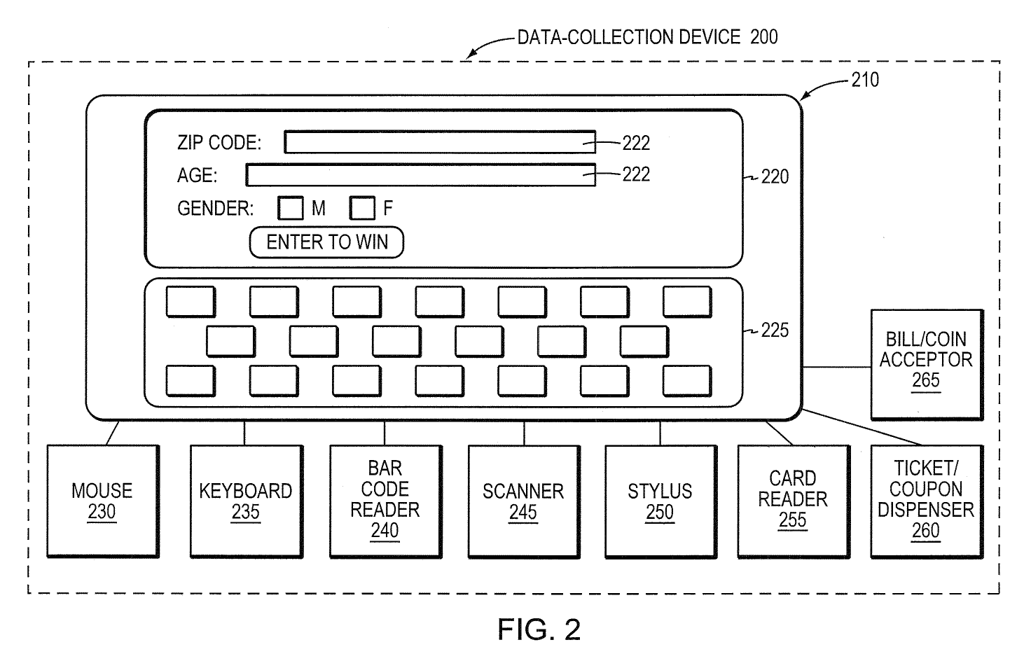

FIG. 2 illustrates an exemplary data-collection device 200 that may be deployed in the targeted-advertising system 100. The device 200 may be implemented as a standalone terminal or as part of a larger kiosk. For example, in some embodiments, the data-collection device may be integrated into a kiosk along with one or more of the display devices 140. The data-collection device is preferably embodied as a general-purpose or special-purpose computer which may be locally configured by a system administrator. For instance, the device 200 may execute an operating system and/or a configuration program that allows the administrator to select a particular software application that prompts customers to enter selected personal data. For instance, the selected application may prompt customers to submit their personal information in order to participate in an ETW promotion or to activate a media-on-demand selection (e.g., a jukebox interface) or to participate in an opinion/market/product survey, etc.

The data-collection device 200 includes a display 210 and at least one data-entry device through which customers can enter their personal data. The display 210 may include an area 220 in which a command-line or graphical-user interface is presented to a customer or system administrator. By way of example, the illustrative fields 222 are presented for a customer to enter his or her zip code, age and gender as a prerequisite for entering an ETW contest. The display 210 also may include an area 225 configured as a touch-screen depicting alphanumeric characters that the customer may use to enter the requested personal data. Other input devices, such as a mouse 230, keyboard 235, barcode reader 240, scanner 245, stylus 250 (e.g., optical) or card reader 255 (e.g., credit card or smart card) alternatively may be used to enter the customer data. Of course, those skilled in the art will appreciate that customer data may be entered using any combination of the above-noted input devices, as well as using other input devices not explicitly listed.

A ticket or coupon dispenser 260 also may be coupled to the data-collection device, e.g., in the event that the device is configured to return a receipt or coupon in response to the customer's submitted data entry. A bill or coin acceptor 265 may be coupled to the device 200 for collecting money required to access pay-for-play or media-on-demand content offered through the data-collection device.

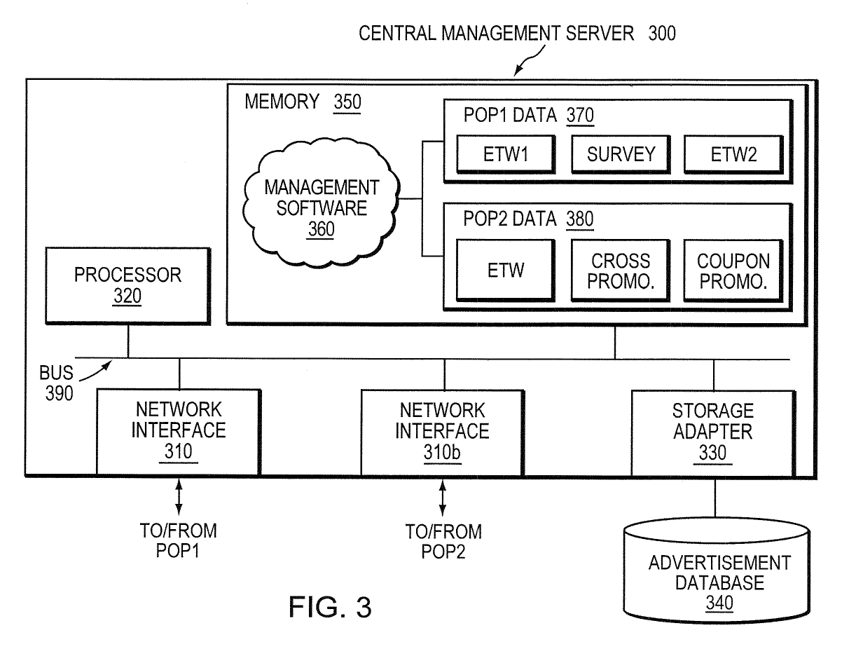

FIG. 3 is a schematic block diagram of an exemplary central management server 300 that advantageously may be used with the present invention. The server comprises a plurality of network interfaces 310, a processor 320, a storage adapter 330 and a memory 350 interconnected by a system bus 390. The network interfaces 310 contain the mechanical, electrical and signaling logic and circuitry for communicating data and control information over physical links 150 coupled to remote points of purchase. The storage adapter 330 contains logic and circuitry for accessing advertisements stored in an attached advertisement database 340. The advertisements may be stored using various digital file formats and compression algorithms, as conventionally known in the art. Preferably, the advertisement database is stored in a mass storage medium, such as a magnetic disk, or in a redundant array of storage mediums.

The memory 350 comprises a plurality of storage locations, which are addressable by the processor 320, network interfaces 310 and storage adapter 330, and are adapted to store program code and data structures associated with the present invention. The processor 320 comprises circuitry and logic adapted to execute the program code and manipulate the data structures. The memory 350 preferably comprises a form of random access memory (RAM) that is generally cleared by a power cycle or other reboot operation (e.g., it is a “volatile” memory). The memory 350 stores, among other things, computer-readable instructions for implementing management software 360 that is configured to select advertisements from the database 340 based, at least in part, on customer-entered data received at the network interfaces 310. Those skilled in the art will appreciate that the memory also may be configured to store other software and data structures besides those explicitly shown. For instance, the memory may store instructions for an operating system (not shown) and may contain a cache buffer for frequently-accessed advertisements loaded from the database 340.

In accordance with the illustrative embodiment, the management software 360 monitors customer statistics received from each point of purchase coupled to the central management server 300. For example, the software 360 may store customer data received from POP1 in a first memory area 370 and customer data received from POP2 in a second memory area 380. In some embodiments, the management software further may organize the customer data within the first and second memory areas based on different types of promotions, surveys, etc. running at the points of purchase. For instance, as shown, the POP1 data may be logically partitioned to reflect which customer-entered data was received in response to a first enter-to-win promotion ETW1, a survey and a second enter-to-win promotion ETW2. Similarly, the illustrative POP2 data is logically partitioned among an ETW promotion, a cross-product promotion and a coupon promotion.

For each point of purchase coupled to the central management server 300, the management software 360 may perform various predetermined statistical analyses to select which advertisements should be loaded from the database 340 and forwarded to the point of purchase. The software may aggregate customer data received from the point of purchase and analyze the aggregated data to identify various demographic trends. Specifically, the management software 360 may employ histograms or other statistical tools and algorithms in its analyses. Further to the illustrative embodiment, the management software selects advertisements that are “targeted” to the identified customer demographics. Preferably, the management software is manually configured, e.g., by a system administrator, to associate which advertisements should be presented to which demographics. Alternatively, the advertisement database 340 may include a mapping (not shown) of advertisements and their targeted audience characteristics, e.g., as specified by a targeted age group, gender, geography, buying habits, and so forth.

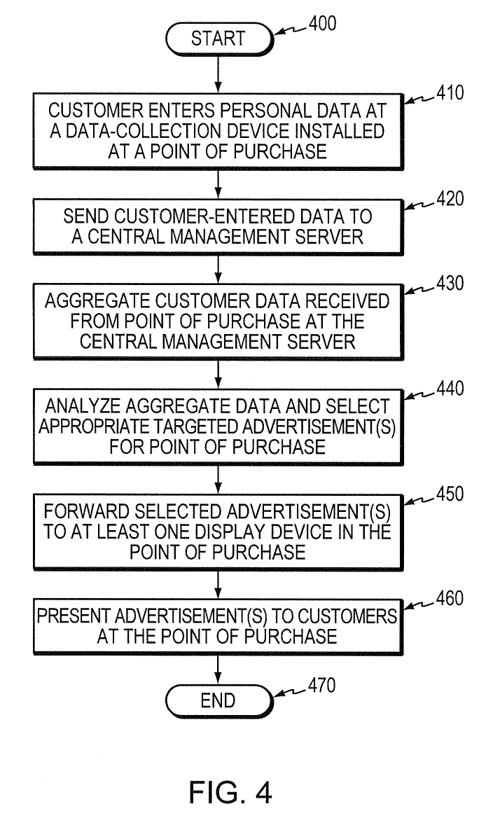

FIG. 4 illustrates a sequence of steps that may be performed for delivering targeted advertising in accordance with an illustrative embodiment of the invention. The sequence starts at step 400 and proceeds to step 410 where a customer enters personal data at a data-collection device 200. The customer may enter the data in response to, e.g., an ETW promotion, opinion/product/market survey, cross-promotion, or the like, presented to the customer at the data-collection device. At step 420, the customer-entered data is forwarded to a POP bridge 130 which in turn forwards the data to a central management server 300. Next, at step 430, the server aggregates the received customer data, then at step 440 analyzes the aggregated data so as to select an appropriate targeted advertisement(s) for the point of purchase. At step 450, the selected advertisement(s) is forwarded to at least one display device 140 which, at step 460, presents the advertisement(s) at the point of purchase. The sequence ends at step 470.

Further to the illustrative embodiment, the inventive targeted-advertising system is used to implement a business method that generates revenue for both a management entity in control of the central management server 300 and a proprietor of the point of purchase. According to this method, the management entity sells advertising time, e.g., in two-minute increments, 30-second increments, etc., to one or more brand advertisers or other advertising sources. The advertisers may include national, regional and/or local organizations who are interested in marketing products or services to specific types of customers. After the advertiser has bought a block of advertising time, the management entity stores the advertiser's targeted advertisements in the central management server.

Next, the management entity cooperates with the advertiser and/or its agents, distributors, etc. to identify at least one point of purchase in which the advertiser's targeted audience is likely to attend. In exchange for permitting the management entity to install and maintain data-collection and display devices, the proprietor of the identified point of purchase is compensated. In accordance with a preferred embodiment, the proprietor is paid rent. For example, the proprietor may be paid a fixed rental amount. The amount, moreover, may be paid on a repeating schedule, such as every month, every quarter, every year, etc. The rent is preferably paid over some length of time provided that the targeted-advertising system remains installed and operating at the business. At the end of the set time period, e.g., five years, ten years, etc., a new arrangement may be entered into between the management entity and the proprietor.

The rental amount, which may be a fixed amount, may be determined based on the expected revenue, e.g., advertising revenue, to be derived from the installed system. The same rental amount may be paid each pay period, or the amount may vary depending on the actual revenue derived from the particular system or on some other metric. For example, the amount to be paid may be computed each scheduled time period, based on the revenue generated during the last scheduled time period. In yet a further embodiment, the rental amount may be some combination of fixed and varying amounts. For example, the rental amount may have a floor regardless of the revenue derived from the installed system with a potential add-on amount if higher than expected revenue is derived from the installed system. A tiered arrangement could also be used. In yet a further embodiment, a single flat-fee or lump sum may be paid by the management entity to the proprietor.

In a further embodiment, depending on federal, state and local laws or regulations, the proprietor may receive a share of the revenue generated from the installed system, such as a share of the revenue collected from the advertising time sold for use at the proprietor's establishment. As such, the proprietor is not responsible for the set-up costs or operational costs of the targeted-advertising system, and instead actually earns a share of the revenue derived from the system.

Besides receiving a revenue share of the sold advertising time, the proprietor also may receive a share of other types of revenue. For instance, the management entity and proprietor may share revenues received from on-site, interactive promotions sold to advertisers, such as enter-to-win promotions, or from media on demand (or “pay for play”) content accessible through the targeted-advertising system. Further, other sources of revenue may be derived from on-line sales or other services offered through the data-collection device, such as music downloads, cell-phone ring tones, cell-phone services, etc. In some embodiments, the management entity and proprietor may share revenues less costs, i.e., profits, rather than sharing the revenues generated by the targeted-advertising system. The costs may include, inter alia, the costs of installing and operating the targeted-advertising system.

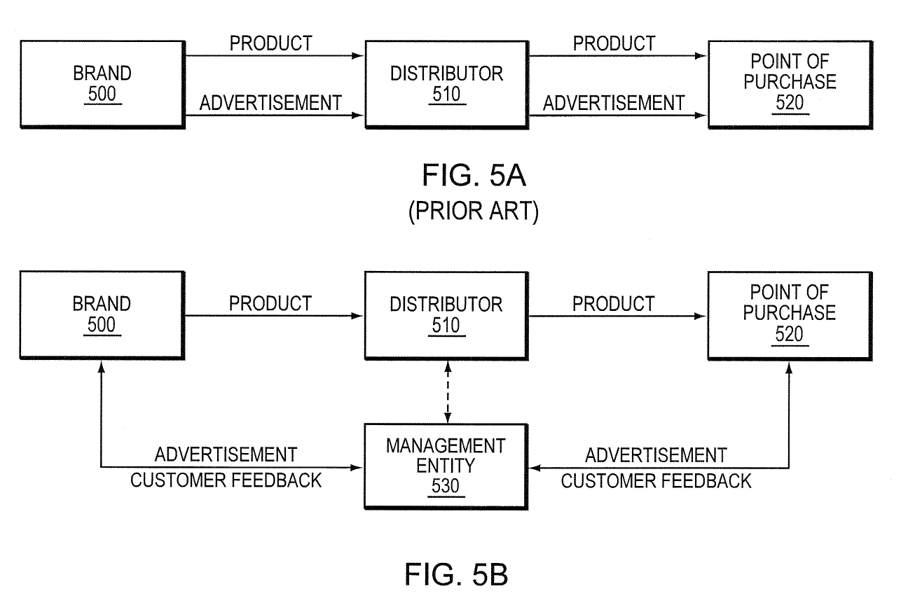

FIG. 5A illustrates an existing business model for distributing products and advertisements between a brand advertiser 500 and a point of purchase 520. According to this prior method, the brand 500 forwards both its product and advertisement to a distributor 510, which then forwards both the product and advertisement to the point of purchase 520. Thus, the flow of advertisements is uni-directional between the brand advertiser and the point of purchase, i.e., the advertisements flow from the brand 500 to the distributor 510 to the point of purchase 520.

FIG. 5B illustrates the new paradigm for delivering targeted advertisements to the point of purchase. As before, the product is forwarded over a uni-directional path from the brand 500 to the point of purchase 520. However, unlike the existing business model, a bi-directional flow is established for targeted advertisements. In particular, a management entity 530 sells advertising time to the brand advertiser 500, and may work with the brand distributor 510 to initially identify a suitable point of purchase 520 in which the brand advertiser should target its advertisements. The management entity installs one or more data-collection devices 200 and one or more display devices 140 at the identified point of purchase, and connects the installed devices over a private, bi-directional network to a remote central management server (as shown in FIG. 1). The management entity contracts to pay rent to the proprietor of the identified point of purchase. As such, the system is installed and operated at virtually no cost to the proprietor.

As customer data is collected at the point of purchase 520, and subsequently aggregated in the central management server, the management entity 530 shares the received customer feedback with the brand advertiser 500 and/or the brand distributor 510. Because the customer feedback provides a more “real time” view of the customer demographics than is possible using existing targeted-advertising systems, the management entity 530 can work with the brand advertiser 500 and distributor 510 to more-specifically tailor its advertisements to match the measured customer demographics at the point of purchase 520. Additionally, the management entity may sort and/or aggregate the customer-entered data, e.g., to generate direct-mailing information for the brand advertiser 500 or distributor 510.

Advantageously, the targeted-advertising system 100 enables the management entity 530 to make scheduling and content adjustments faster than is possible using previous systems. For example, suppose the brand advertiser 500 initially buys advertising time for presenting a first advertisement at a point of purchase coupled to the targeted-advertising system. The advertiser later may contact the management entity, requesting that the first advertisement be replaced with a different, second advertisement. By reconfiguring the content and scheduling information at the central management server 300, the management entity can quickly effectuate the requested advertisement change at the point of purchase.

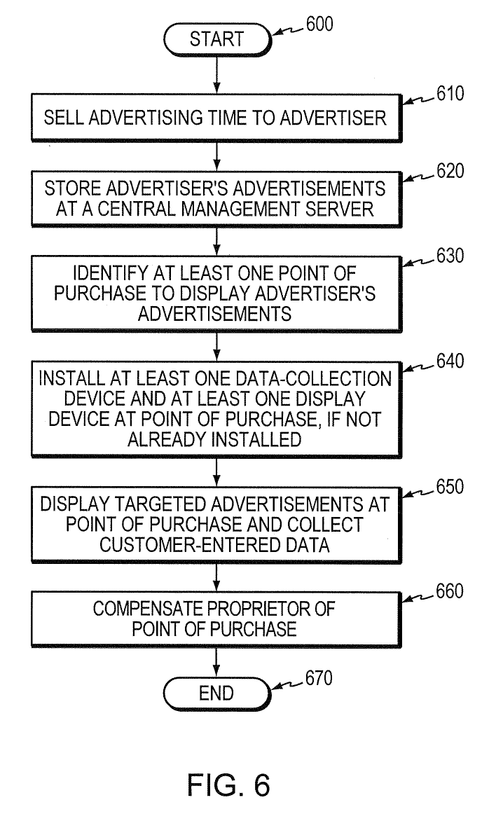

FIG. 6 illustrates a sequence of steps that may be performed for implementing the illustrative business method of the present invention. The sequence starts at step 600 and advances to step 610 where the management entity 530 sells advertising time to the brand advertiser 500, e.g., in two-minute increments or other predetermined time intervals. At step 620, the management entity stores the advertiser's advertisements at a central management server 300 managed by the entity 530. Next, the management entity identifies at least one point of purchase 520 to display the advertiser's advertisements, at step 630. To that end, the entity may communicate with the brand advertiser and/or its distributors to select the point of purchase, e.g., based on previously-measured (or forecasted) buying habits or customer statistics associated with the point of purchase. At step 640, the management entity 530 installs at least one data-collection device 200 and at least one display device 140 at the selected point of purchase 520, if such devices are not already installed.

Next, at step 650, the brand advertiser's targeted advertisements are displayed at the point of purchase, and customer-entered data may be collected at the point of purchase and forwarded to the server 300. Based on the collected customer data, the management entity 530, brand advertiser 500 and/or brand distributor 510 may fine-tune which targeted advertisements are presented at the point of purchase 520. As such, the advertiser's advertisements can be targeted to a more “real time” view of the customer demographics than is possible using prior advertising systems. At step 660, the management entity compensates the proprietor of the selected point of purchase.

As described above, in alternative embodiments, the proprietor may receive, alternatively or additionally to rent, a portion of the revenues (or profits) derived from the advertising time purchased by the brand advertiser and/or other revenue sources. For instance, such other revenue sources may include, among other things, pay-for-play or media-on-demand revenues collected at the point of purchase, ETW promotions sold to the brand advertiser or distributor, and so forth. The sequence ends at step 670.

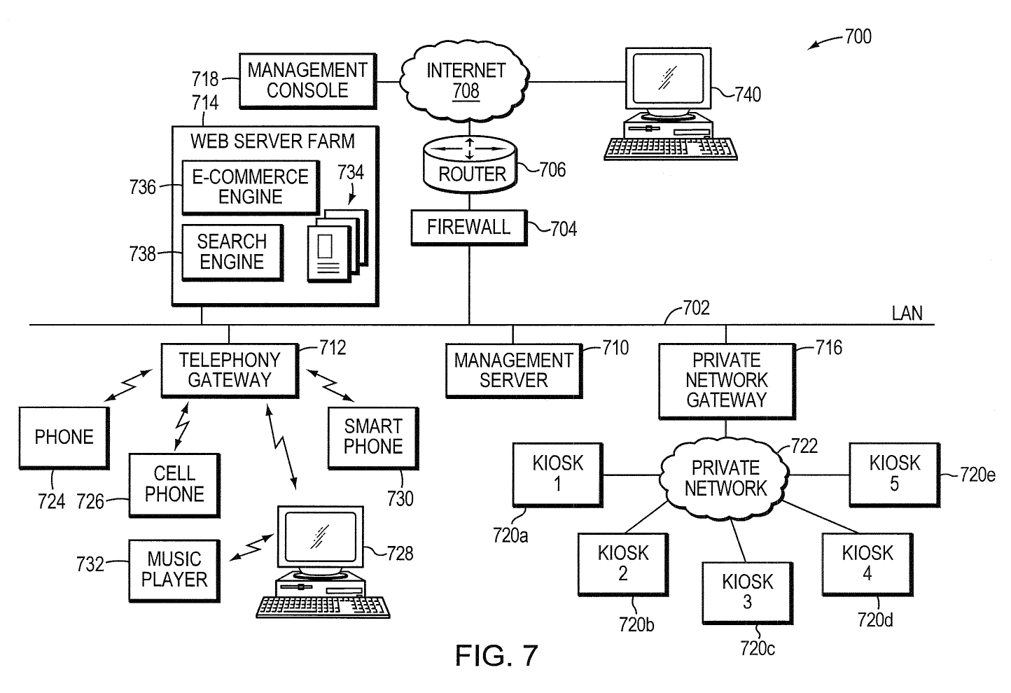

FIG. 7 is a highly schematic illustration of a system 700 according to another embodiment of the present invention. System 700 includes a local area network (LAN) 702 that is coupled, preferably through a firewall 704 and internetworking device 706, such as router, to the Internet 708. Also coupled to LAN 702 is a management server 710, a telephony gateway 712, one or more servers, which in the illustrative embodiment are organized as a web server farm 714, and a private network gateway 716. As described in more detail herein, the management server 710 controls the system 700. In the illustrative embodiment, a system administrator accesses the system 700 through a management console 718 coupled to the Internet 708 and thus to the management server 710 through router 706 and LAN 702. Those skilled in the art will understand that management console could alternatively or additionally be connected to LAN 702, to management server 710, or other elements of the system 700. The private network gateway 716 provides communication to and from LAN 702 and a plurality of interactive kiosks, such as kiosks 720a-e. In the preferred embodiment, this communication between the LAN 702 and the kiosks 720 is through a private network 722. As described herein, each kiosk 720 is preferably installed in a different location. More specifically, each kiosk 720 is preferably installed in a place of public accommodation. An exemplary place of public accommodation is a hospitality type establishment, such as a bar, lounge, restaurant, etc., that is frequented by patrons and customers.

In the illustrative embodiment, the private network gateway 716 includes or is a digital subscriber line access multiplexer (DSLAM), and the private network 722 is a series of Digital Subscriber Line (DSL) connections, where each DSL connection leads to one of the kiosks 720a-e. The DSLAM and DSL connections provide high-speed data connections to and from the kiosks 720a-e. Those skilled in the art will understand that other communication equipment besides DSLAM and DSL connections, such as cable modems and cable lines, or satellite connections may be used.

The private network gateway 716, the private network 722 and the kiosks 720 may be configured to operate according to one or more communication protocols, such as those described in the TCP/IP communication protocol stack. Alternatively, a specialized, proprietary communication protocol may be developed and used.

The telephony gateway 712 provides communication to and from LAN 702 and a plurality of devices, such as a phone 724, a cell phone 726, a personal computer (PC) 728, which may be a desktop computer, a laptop computer, etc., and a smart phone 730. The PC 728, moreover, may interface to one or more other devices, such as a portable music player 732, e.g., a MP3 player, an iPod player from Apple Inc. of Cupertino, Calif., etc.

The telephony gateway 712 may operate in accordance with the Wireless Application Protocol (WAP) standard. Suitable equipment for use as a telephony gateway includes the NetLink Telephony Gateway from SpectraLink Corp. of Boulder, Colo.

The web server farm 714 preferably includes a plurality of web servers, shown generally at 734. At least some of the web servers 734 are configured to host secure websites accessible through firewall 704 and router 706, telephony gateway 712 or private network gateway 716. Other web servers may be configured for data storage. In addition, the web server farm 714 includes an electronic commerce (e-commerce) engine 736 for processing payment transactions, such a credit or debit card transactions, and a search engine 738 for searching content on the web servers 734. Those skilled in the art will understand that the e-commerce engine 736 and/or the search engine 738 may be hosted on one or more of the web servers 734.

Access to LAN 702 may also be accomplished through the Internet 708 and router 706 as illustrated by personal computer 740 coupled to the Internet 708.

Those skilled in the art will understand that system 700 may include additional components, or several of the illustrated components could be combined. For example, the functionality of the private network gateway 716 and private network 722 could be incorporated into the telephony gateway 712.

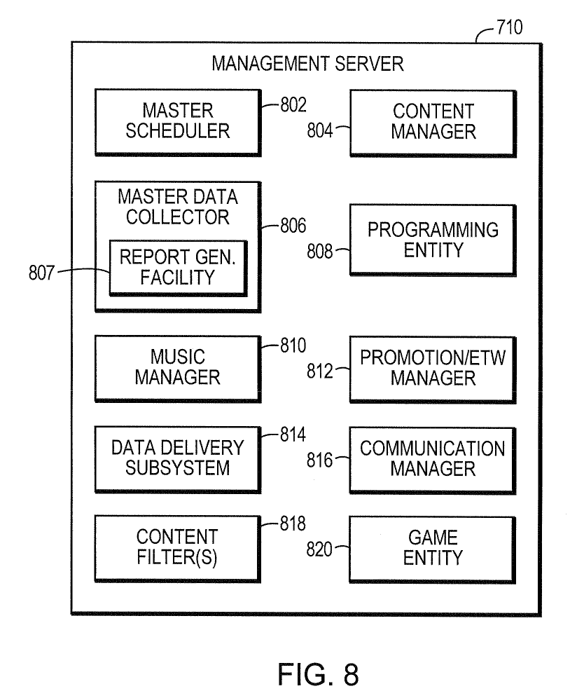

FIG. 8 is a highly schematic, functional block diagram of a preferred embodiment of the management server 710. Management server 710 includes a master scheduler 802, which schedules the playing and/or availability of content at the kiosks 720, a content manager 804, which manages the content stored on the system 700, including the kiosks 720, a master data collector 806, which collects and organizes data from the kiosks 720, a programming entity 808, which programs the kiosks 720, and a music manager 810, which manages music stored at the web server farm 714 and on the kiosks 720. The master scheduler 802 preferably includes or has access to a clock (not shown). The master data collector 806, moreover, may include a report generating facility 807.

The management server 710 further includes a promotion/enter to win (ETW) manager 812, which manages promotions and contests being run by the system 700, a data delivery subsystem 814, which downloads information, including data, commands, and content to the kiosks 720, a communication manager 816, which manages the system's communication channels, such as those to and from the kiosks 720, one or more content filters 818 that filter content that is being sent to the kiosks 720 and to the web server farm 714 from users and/or patrons, and a game entity 820, which manages games that may be run by the system 700. Those skilled in the art will understand that each component of the management server 710 may be its own software, hardware and/or combination software/hardware module. Alternatively, several of the components may be combined into a single software, hardware and/or combination module.

As described herein, the master scheduler 802 controls when content, such as music, videos, promotions, enter to win (ETW) or other contests, etc., are played and/or made available at a given kiosk 720. For example, the system administrator may access the management server 710 through the management console 718, and schedule a particular song or contest to be played at a given kiosk, e.g., kiosk 720c at the ABC Bar and Lounge, at a particular date and time, e.g., Thursday at 9:00 p.m. As discussed herein, the master scheduler 802 issues commands to kiosk 720c to play the selected song or contest at the specified date and time. The master scheduler 802 also interfaces with the content manager 804 which, in turn, interfaces with the data delivery subsystem 814 and the communication manager 816, to ensure that the selected song or contest has been downloaded to and is thus available at kiosk 720c in time for the scheduled play-back.

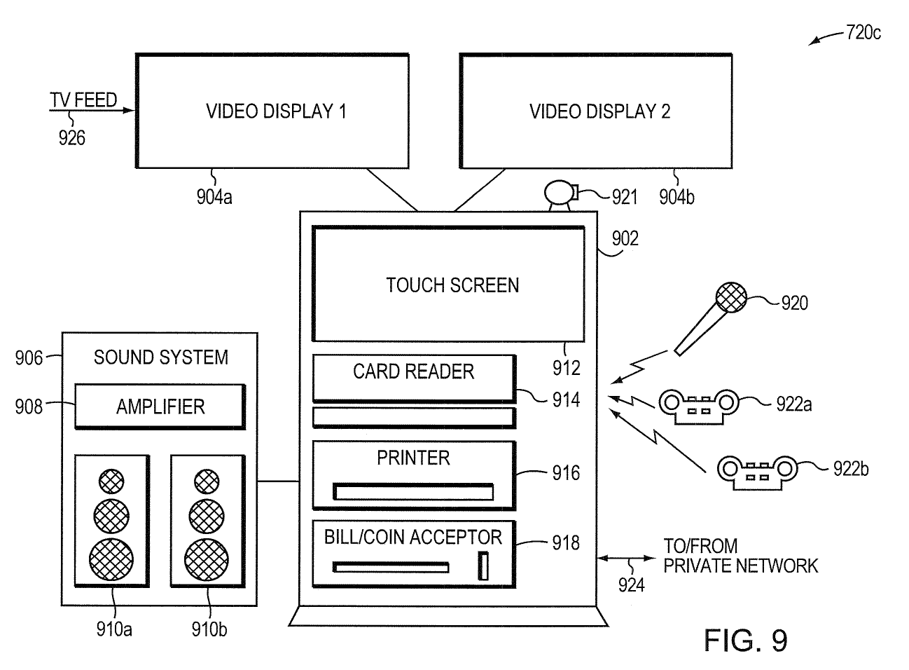

FIG. 9 is a highly schematic illustration of a kiosk, such as kiosk 720c, which has been installed at the ABC Bar and Lounge. The kiosk 720c includes a kiosk terminal 902, sometimes referred to simply as a terminal, and multiple, e.g., first and second, video displays 904a and 904b that are connected to the terminal 902. In the preferred embodiment, each video display is a large, e.g., preferably over 42 inches, plasma television, although those skilled in the art will understand that other video displays may be used, such as an LCD display, among others. The terminal 902 preferably connects to a sound system 906 that is separate from the terminal 902. The sound system 906 may include an amplifier 908 and speakers 910a-b. The terminal 902 preferably includes a touch screen 912, a card reader or swipe 914 for reading credit, debit or other cards, such as driver's licenses, loyalty cards, etc., a printer 916 for producing printed material, such as coupons, receipts, etc., and a bill and coin acceptor 918, for receiving money from a patron.

In the illustrative embodiment, the terminal 902 includes other elements, which may be used by the patron to interact with the kiosk 720c. For example, the terminal 902 may include a wireless microphone 920 so that a patron may perform karaoke, a video camera 921 to capture images of patrons performing karaoke, one or more game controllers 922a-b, so that patrons may play games on the kiosk 902, a bar code reader (not shown), etc. It should be understood that the microphone 920 and/or game controllers 922 may be built into the kiosk terminal, rather than being separate from it.

The terminal 902 connects to the private network 722 (FIG. 7) as indicated by double arrow 924. In addition, in the illustrative embodiment, a TV feed is provided to one of the video displays, e.g., first display 904a, as indicated by arrow 926. The TV feed may be received from a cable television provider, a satellite television provider, etc., and has a plurality of channels or stations that can be selected for display.

In the preferred embodiment, the terminal 902 is a free-standing unit, and is placed in an area that is accessible by patrons or customers of the establishment.

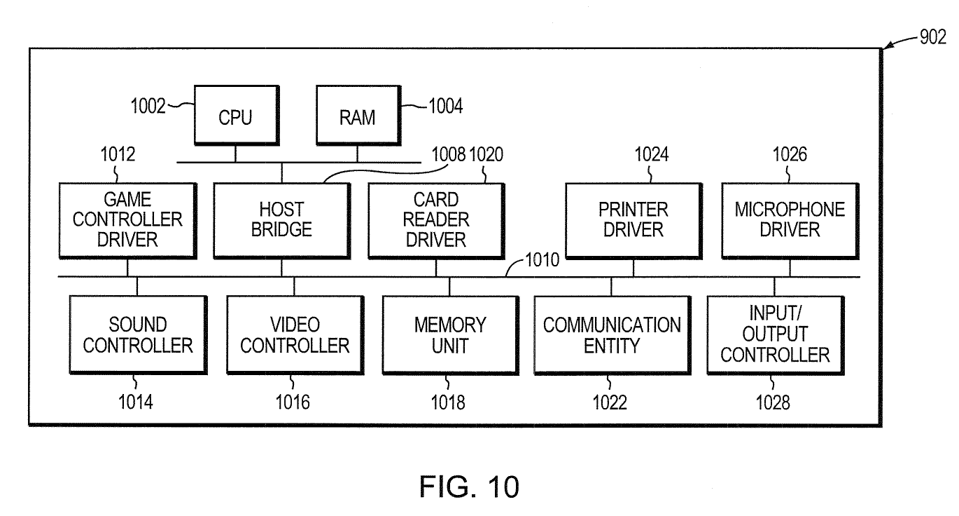

FIG. 10 is a highly schematic illustration of at least some of the components of a terminal 902. In particular, the terminal 902 includes a processor, such as a central processing unit (CPU) 1002 and a Random Access Memory (RAM) 1004 that are coupled via a main bus 1006. Also connected to the main bus 1006 is a host bridge 1008 that interfaces between the main bus 1006 and a secondary bus 1010 to which a plurality of components are coupled. In particular, terminal 902 further includes a game controller driver 1012 for interfacing with the game controllers 922a-b (FIG. 9), a sound controller 1014 for interfacing with the sound system 906, a video controller 1016 for interfacing with the video displays 904, and a memory 1018, which in the preferred embodiment is an external hard drive so that it can be swapped out as necessary. Terminal 902 further includes a card reader driver 1020 that interfaces with the card reader 914, a communication entity 1022, which may be a DSL modem, for interfacing with the private network 722, a printer driver 1024 for interfacing with the printer 916, microphone driver 1026 for interfacing with the microphone 920, and an input/output (I/O) controller 1028 for interfacing with the touch screen 912 and other I/O devices.

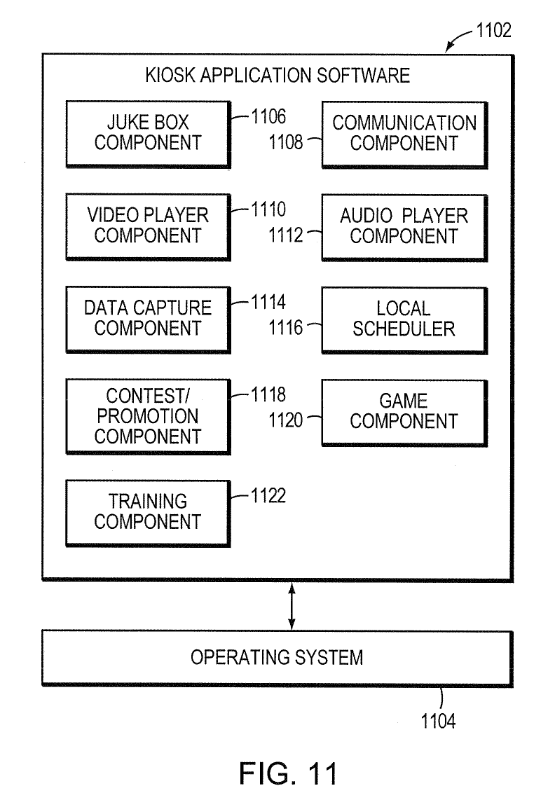

FIG. 11 is a highly schematic, functional diagram of the terminal 902. The terminal 902 includes a kiosk software application 1102 that interfaces with an operating system 1104. A suitable operating system is Windows XP from Microsoft Corp. of Redmond, WA. Those skilled in the art will understand that other operating systems may be used, such as Linux. The kiosk software application 1102, moreover, preferably includes a plurality of modules. More specifically the kiosk software application 1102 includes a juke box component 1106, a communication component 1108, a video player component 1110, a sound or audio player component 1112, a data capture component 1114, a local scheduler 1116, a contest/promotion component 1118, a game component 1120, and a training component 1122. The local scheduler 1116 preferably includes or has access to a clock. This clock is preferably synchronized with the clock at the management server 710.

As described herein, system 700 is, among other things, a highly flexible, dynamic content management, display and data collection system that supports multiple modes of operation. In particular, the first video display 904a, which as described above receives the TV feed 926, preferably displays a selected television channel or station. A patron or employee of the establishment in which the kiosk is located, for example, can select the channel through a TV/cable/satellite remote control (not shown). The audio portion of the selected television channel is received by the terminal 902 from the first video display 904a and is provided by sound controller 1014 to the sound system 906.

As described herein, each kiosk 720 supports a plurality of operating modes. In some cases, a kiosk 720 can run multiple modes simultaneously.

Advertising Mode

In an advertising mode, the second video display 904b preferably displays advertisements. Video advertisements may be provided to the kiosk 720 for playback as follows. An advertiser generates an electronic advertisement, e.g., a video file, and provides it to the system administrator. The advertisement may or may not include an audio component. Exemplary advertisements include infomercials, movie trailers, and product or service advertisements, such as an advertisement for a beverage. By operating the management console 718, the system administrator accesses the LAN 702, and stores the advertisement on the web server farm 714. The network administrator then operates the master scheduler 802 at the management server 710 to schedule the advertisement to be played by a kiosk 720 at a selected data and time. The system administrator may schedule the advertisement to play on a periodic basis, e.g., once an hour at the top of the hour, every other hour during the evening for three days, etc.

The master scheduler 802 and the content manager 804 then cooperate to determine which kiosks 720 need to have the advertisement available locally for display, based on the schedule decided upon by the system administrator. The content manager 804 cooperates with the data delivery subsystem 814 and the communication manager 816 to send copies of the advertisement to the selected kiosks 720 via the private network 722. In the illustrative embodiment, the data delivery subsystem 814 and the communication manager 816 send data to the kiosks 720, preferably when the establishments at which the kiosks are located are closed. At the kiosks 720, the advertisement is received and stored at the memory unit 1018. The local schedulers 1116 at the kiosks also receive instructions from the master scheduler 802 regarding when the advertisement is to be played. When the specified time(s) occurs, the local scheduler 1116 retrieves the advertisement from the memory unit 1018 and displays it on the second video display 904b. Preferably, the local scheduler 1116 determines whether a program is currently being played on the first video display 904a. If so, the local scheduler 1116 can be configured to wait until the current program is over before displaying the advertisement or other content. Alternatively, the local scheduler 1116 could be configured to interrupt the current program and play the advertisement.

In a preferred embodiment, the local schedulers 1116 at the kiosks 720, during operating hours of the establishment at which the kiosk is located, play many different advertisements each of which is stored at its respective memory unit 1018. These advertisements are played according to the schedule that the kiosk 720 receives from the master scheduler 802.

It should be understood that a similar process may be used to play other content on a scheduled basis, such as a song that is being promoted by a record or music company, or a movie trailer, or a promotion developed by a entity, such as a food or beverage company.

It should be further understood that, by virtue of the architecture of the system 700 of the present invention, the system administrator may target specific content to specific kiosks 720. That is, a given advertisement, promotion, song or other content may be targeted to just a subset of the kiosks 720. The selection of such kiosks may be made based on various factors, such as type of establishment at which the kiosk is located, the type of patrons that frequent the establishment, etc.

Juke Box Mode

The kiosk 720 may also be operated in a juke box mode. The music manager 810 at the management server 710 preferably causes music content, i.e., electronic music files, such as MP3 files, iTunes files, etc., to be downloaded to and stored at the memory units 1018 of the kiosks 720. In particular, the system administrator, acting through the management console 718, directs the management server 710 to store music at the kiosks 720. Alternatively, the memory unit 1018 may be pre-configured with music files. For example, the memory unit 1018, which as described above may be an external hard drive, may be loaded with music files at a location remote from the establishment at which the kiosk 720 is located. The configured memory unit 1018 may then be taken to and installed at the kiosk 720. It should be understood that the system administrator may direct the management server 710 to only send certain selected songs, or songs of a certain genre, e.g., blues, rock, country, etc., to a particular kiosk 720 depending on the establishment at which the kiosk is located. In any event, each kiosk 720 preferably stores numerous songs in its respective memory unit 1018. These songs can be selected by a patron and played.

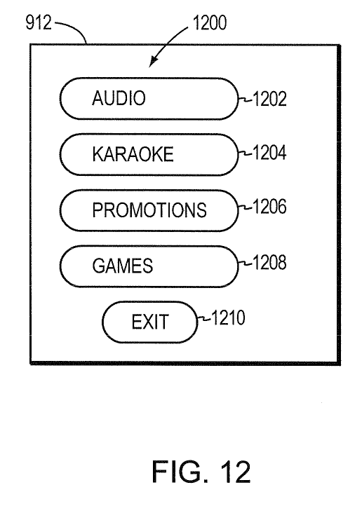

In particular, the touch screen 912 at the kiosk terminal preferably displays a top-level screen that presents a patron with several top-level command or option buttons. FIG. 12 is a highly schematic illustration of a top-level screen 1200 displayed on touch screen 912. As shown, the top-level screen 1200 includes an “Audio” button 1202, a “Karaoke” button 1204, a “Promotions” button 1206, and a “Games” button 1208. It may also include an “Exit” button 1210. By touching the “Audio” button 1202, the patron can operate the kiosk 720 in juke box mode. Specifically, in response to selecting the “Audio” button 1202, the kiosk causes the touch screen 912 to display a user interface for selecting one or more songs to be played. For example, the touch screen 912 may display a list of the songs stored on memory unit 1018. The list may be organized in a desired manner, e.g., by artist, by genre, by title, etc., and may be reorganized and/or searched by the user.

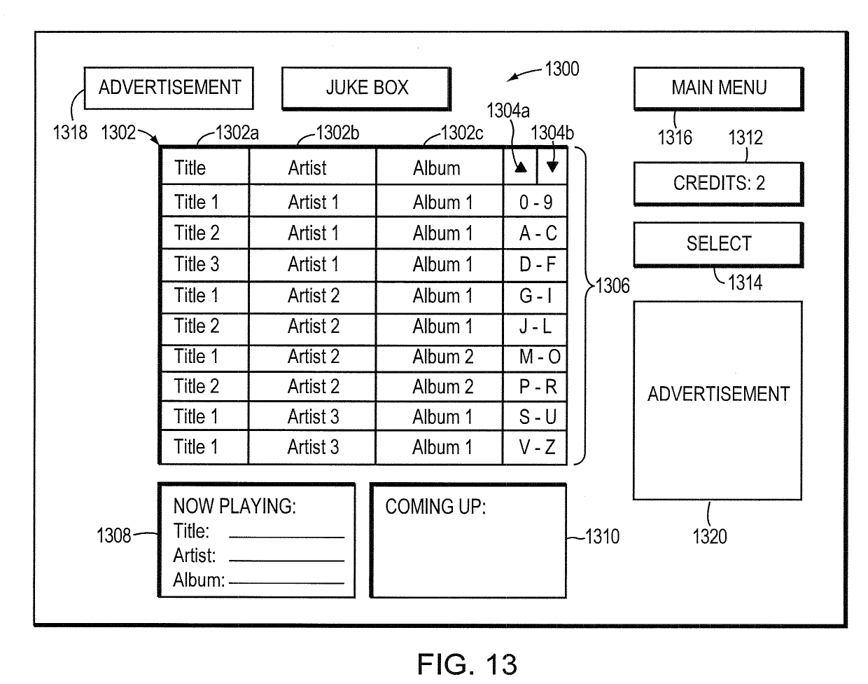

FIG. 13 is a highly schematic illustration of a juke box command screen 1300 displayed on touch screen 912. The juke box command screen 1300 preferably includes a music content region 1302 that displays the list of songs that can be selected for playing. The music content region 1302 may be organized by Title 1302a, Artist 1302b, and Album 1302c. It may also include a series of navigation buttons, such as scroll up/down buttons 1304a and 1304b and alpha-numeric 1306 selection keys, for moving around the list of songs. The screen 1300 may also have a now playing region 1308, which displays information regarding the song currently being played. A coming-up region 1310 may list the song(s) previously selected by a patron, and currently queued up for playback. A credits area 1312 shows the current user how many more songs he or she may select before having to pay additional money. A select button 1314 may be pressed by the current user to select a highlighted song from the song list. A main menu button 1316 can be used to return to the top-level screen 1200. In addition, the juke box command screen 1300 preferably displays one or more advertisements to the user, such as advertisements 1318 and 1320, such as banner advertisements, video advertisements, etc.

It should be understood that juke box command screen 1300 may display other items or things, such as previously created play lists, etc.

The patron may pay for the playing of a selected song by entering money into the bill/coin acceptor 918 and/or swiping his or her credit or debit card at the card reader 914. The patron selects the songs that he or she wishes to have played by operating the touch screen 912. In response, the juke box component 1106 accesses the selected song(s) from the memory unit 1018 and, together with the audio player component 1112, causes the selected song(s) to be played through the sound system 906.

If the patron used a credit or debit card to pay for the song(s), the kiosk terminal 902 preferably communicates with the e-commerce engine 736 at the web server farm 714 to complete the transaction.

To encourage patrons to interact with the kiosk 720, the local scheduler 1116 may be configured to cause the juke box component 1106 to periodically play a song, even though no song was selected by a patron.

In a further embodiment, a patron may operate the juke box mode of a kiosk 720 by using his or her cell phone. Specifically, the kiosk 720 may be configured to display a web address and/or phone number as well as a code on the touch screen 912 and/or on the second video display 904b. A patron can use his or her cell phone to access this web site, e.g., through the web browsing capabilities of his or her phone, or may call the displayed phone number. The web address leads to the web server farm 714, e.g., via the Internet 708 or the telephony gateway 712, and the phone number similarly leads to the web server farm 714 via the telephony gateway 712. The web server farm 714 hosts one or more interactive web pages. The patron interacts with the web page(s) to select a song for playback on the kiosk 720. For example, the web server may present a web page for display on the patron's cell phone, and the patron may interact with the web page to select a desired song. Alternatively, the patron may enter a text message or navigate voice prompts to select a desired song.

The code, which is needed to operate the juke box mode of the kiosk 720 in this way, is preferably displayed by the kiosk 720 so that a patron outside of the establishment, but who nonetheless remembers or knows the web address or phone number, is prevented from causing music to be played at the establishment while he or she is someplace else. That is, while the web address and phone number may remain the same for some period of time, the code is preferably updated or changed periodically by the system 700.

Music Purchasing Mode

A patron may also purchase music from a kiosk 720 through a music buying mode of operation. More specifically, after selecting the “Audio” button from the top-level menu, the user may be presented with an option to purchase music through a screen displayed on touch screen 912. Upon selecting this option, the patron may be presented with a list of songs available for purchase at the kiosk 720. The patron may then select a desired song, and purchase it by feeding money into the bill/coin acceptor 918 or by swiping his or her credit card at the card reader 914. As described above, the kiosk 720 may communicate with the e-commerce engine 736 at the web server farm 714 to complete the credit card/debit card transaction. Upon purchase, the patron may be given receipt with a purchase code through the printer 916. The patron, using his or her PC 728, can then access a web site hosted on the web server farm 714, enter the received purchase code, and download the purchased song to his or her PC 728. Once downloaded, the patron can load the purchased song onto his or her portable music player 732.

In an alternative or additional embodiment, the kiosk terminal 902 may be equipped with a communication port, such as USB port. In this embodiment, the patron may connect his or her portable music player 732 directly to the kiosk terminal 902, and download the purchased song directly into his or her portable music player 732.

In yet another embodiment, the patron may access the web site offering the song through his or her cell phone. This access to the web site is handled by the telephony gateway 712 preferably as described above.

It should be understood that a kiosk terminal 902 may similarly be operated to purchase video content in addition to music. For example, a patron or customer could purchase a movie clip, a TV program, a music video, etc.

Karaoke Mode

A kiosk may also be operated in a karaoke mode. Here, the patron selects the “Karaoke” button 1204 from the top-level menu 1200 displayed on the touch screen 912. As in the juke box mode, a plurality of songs are displayed that can be selected by the patron. The patron preferably purchases the karaoke performance in a similar manner as described above regarding the juke box mode. The audio player component 1112 retrieves the selected song and causes it to be played through the sound system 906. In addition, the video player component 1110 may cause the lyrics of the selected song to be displayed on the second video display 904b. The patron uses the microphone 920 to sing the song. The output of the microphone 920 is received by the kiosk terminal 902, which provides that signal to the sound system 906.

In a further embodiment, the image of the patron while he or she performs the karaoke song may be captured by the video camera 921. This image signal may then be displayed on the second video display 904b and/or stored at the kiosk 720.

Promotion/Contest Mode

The kiosk 720 may be operated in a promotion or contest mode. The promotions or contests may be enter-to-win contests in which the winning entrant wins a prize, such as sporting tickets, sporting goods, such as a bike, consumer electronics, such as an MP3 player, a DVD player etc., or other types of promotions or contests. In the illustrative embodiment, a promotion or contest is preferably hosted, e.g., run, on one of the web servers 734 of the web server farm 714. In addition, all or portions of the promotions or contests, which may include video files, created by the promoters or advertisers may be downloaded to and stored at the memory units 1018 of the kiosks 720, as may be done with other content. These contests or promotions can then be accessed through the kiosk terminal 902 by a patron who can choose to enter a selected contest or promotion. In the illustrative embodiment, a patron views and enters the promotions or contests available at the kiosk 720 through the touch screen 912.

In particular, the top-level menu 1200 of the touch screen 912 preferably includes a “Promotions” button 1206. If selected, the touch screen 912 then displays the promotions that have been downloaded to, and are currently available at the kiosk 720. The patron can view those contests or promotions, and choose to enter one or more of them.

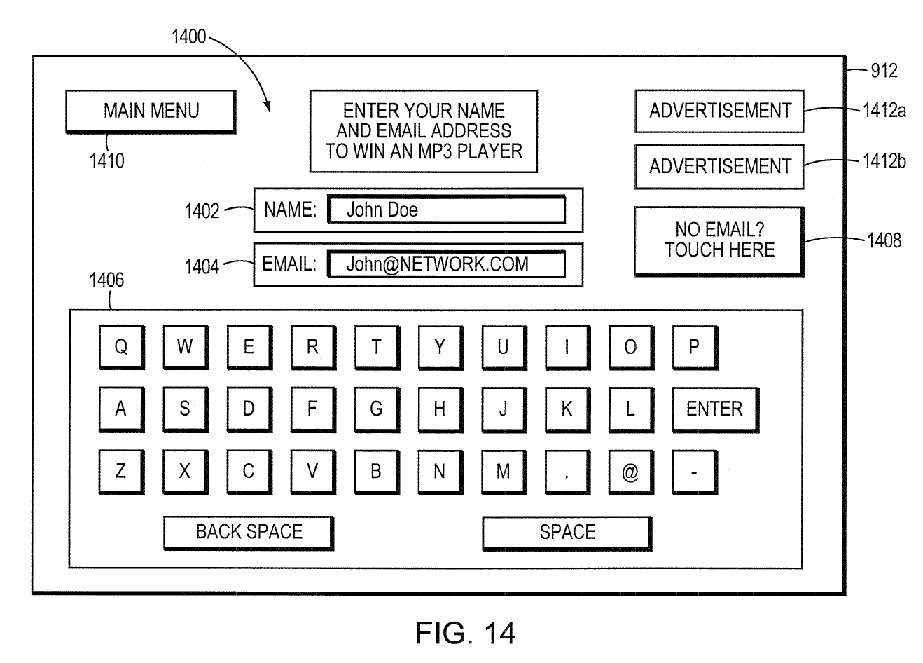

In particular, upon choosing a desired promotion or contest, e.g., by selecting commands or options displayed on the touch screen 912, the touch screen 912 preferably displays a data entry screen to the patron. FIG. 14 is a highly schematic illustration of a preferred data entry screen 1400. The data entry screen 1400 preferably includes a plurality of fields for receiving information from the patron, such as a name field 1402 for receiving the entrant's name, and an email address field 1404 for receiving the entrant's email address. Additional fields may be displayed to receive other information, such as the entrant's phone number, address, zip code, etc. The patron can use an alpha-numeric display 1406 to enter the requested information, thereby entering his or her name in the promotion or contest. Data entry screen 1400 may also include a button 1408 that may be pressed if the entrant does not have, or does not wish to enter, an email address. In response to button 1408 being pressed, the kiosk 720 may cause a new screen or more fields to be displayed on screen 912 to accept other information from the entrant, such as phone number and address, as indicated above. Data entry screen 1400 may also include a main menu button 1410 that, when pressed, causes the top-level display 1200 to be displayed. In a preferred embodiment, the data entry screen 1400 also displays one or more advertisements, such as advertisements 1412a and 1412b.

In the illustrative embodiment, the information entered by the patron is captured by the local data capture component 1114 at the kiosk terminal 902, and sent to the master data collector 806 at the management server 710. The management server 710 forwards the data to the web server farm 714 for receipt by the web server that is hosting the particular promotion or contest. The web server may include software for selecting a winner after the promotion or contest has closed, or a winning entry may be selected as described below.

The web server can then forward the identity of the winner to management server 710 which, in turn, may pass that information down to the kiosk(s) 720 at which the promotion or contest was offered. The kiosk terminal 902 may then display information about the winner, such as his or her name, on the touch screen 912 and/or the second video display 904b. Additionally, the web server may contact the winner by sending him or her an email, a text message and/or by placing an automated call to the telephone number that was entered.

The system administrator may also schedule the playing of video displays regarding the promotions or contests at selected times. Specifically, as with the scheduling of other content, the system administrator may schedule an advertisement for a promotion or contest to be displayed on the second video display 904b at selected time(s). When the designated time occurs, the video player component 1110 at the kiosk terminal 902 accesses the video file corresponding to the contest, and plays it on the second video display 904b and/or on the touch screen 912. In this way, patrons may be encouraged to visit the kiosk terminal 902, and enter the promotion or contest.

It should be understood that the system 700 may support multiple ways for patrons and others to enter promotions and contests besides through the touch screen 912 of the kiosk terminal 902. For example, the advertisement for a promotion or contest that is played on the second video display 904b may include a call-in number. In this case, a patron, seeing the call-in number, may use his or her cell phone to call the number being displayed. The telephone number is selected to lead to the telephony gateway 712, which converts the call into one or more data messages that can be passed to the web server, located on the web server farm 714, that is hosting or running the promotion or contest for which the patron is calling. The web server may generate voice commands instructing the patron to enter his or her information through the keys of the patron's cell phone. Alternatively or additionally, the web server may receive information spoken by the patron, and use a speech-to-text converter to generate corresponding textual information. Alternatively, the entrant may send a text message to enter the contest or promotion.

In yet a further embodiment and as also described below, a web site hosted at the web server farm 714 may be established for some or all of the kiosks 720. That is, for kiosk 720c at the ABC Bar and Lounge, a corresponding website is established and hosted at the web server farm 714. The web address for this web site may be displayed by the kiosk terminal 902 on the touch screen 912 and/or on the second video display 904b. A patron, using the web browsing capability of his or her cell phone, while at the establishment, may access the web site through the Internet 708 and enter the contest. Alternatively, a patron who is not currently at the ABC Bar and Lounge, but knows the web address from prior visits or through an Internet search, may access the web site through his or her PC 728, 740 while at home. The web site may be configured to present the same promotions or contests to the user that are available through the kiosk terminal 902. The patron, who in this example is not currently at the ABC Bar and Lounge, can nonetheless enter the promotion or contest, by entering his or her information through his or her PC 728, 740.

Those skilled in the art will recognize that the system 700 of the present invention can support many different types of contests, such as a trivia contest, and other uses.

For example, a best karaoke contest could be run among multiple establishments at which kiosks 720 are located. In this case, the karaoke sound and image being captured at a first kiosk 720 by camera 921 and microphone 920 may be sent to the management server 710 which, in turn, is programmed to send the karaoke sound and image to other kiosks 720 in other locations for display on their video displays 904. Once each participant has completed his or her performance, the patrons at all of the establishments can vote for the best karaoke performer, e.g., through the touch screen 921.

To prevent improper, e.g., indecent, images from being displayed on the second video display 904b, the video signal may be passed through the content filter(s) 818 at the management server 710, which may be programmed to identify and block improper images. Additionally or alternatively, one or more human operators may monitor the video about to be displayed at the video displays 904 of the kiosks 720, and block the display of improper images.

In another example, a best video contest may be run. In this case, entrants create a video and send it to an email address established for one of the servers. That is, one or more of the servers may be configured as a mail server. The management server 710 causes the received video submissions to be sent to one or more of the kiosks 720 for display at a given time. Patrons or customers watch the videos on the second video display 904b, and vote for their favorite one, e.g., through the touch screen 912 and/or their cell phones. A prize may then be awarded to the person who submitted the winning video entry.

Game Console

The kiosk 720 may also be operated in an electronic game playing mode. To enter this mode, a patron preferably presses the “Games” button 1208 from the top-level menu 1200 at the touch screen 912. In response, the touch screen 912 displays the games currently available for playing on the kiosk 720. The patron preferably selects a desired game to be played. Exemplary games include car racing games, aircraft flying games, war simulation games, sports, video arcade type games, etc. Upon selection by the patron, the game component 1120 retrieves the selected game from the memory unit 1018, and causes it to be run. The video component of the game is preferably displayed on a dedicated game display (not shown), which may be its own plasma or LCD display, and any audio component is passed to the sound system. Alternatively, the video component may be displayed on the second video display unit 904b. The patron preferably uses the game controller(s) 922a, 922b, to play the selected game. As in the juke box and karaoke modes, the patron pays for the game by inserting money into the bill/coin acceptor 918 or swiping his or her credit or debit card in the card reader 914.

To operate in the electronic game playing mode, a game system, such as the PlayStation® system from Sony Corp. of America of New York, N.Y., or the Xbox system from Microsoft Corp. of Redmond, Wash., may be installed in the kiosk 720.

It should be understood that the kiosk 720 may be configured to allow patrons at multiple kiosks 720 to play the same game. That is, the kiosks 720 may operate in a “networked” environment. Such networked operation of the kiosks 720 is preferably controlled by the manager server 710.

It should be understood that the system administrator may disable one or more of the modes of a kiosk 720 and/or control the hours during which selected modes can be run. For example, the system administrator may, using the master scheduler 802, control a kiosk 720 such that the karaoke and game modes are disabled for a certain period of time each day, e.g., until 9:00 p.m., or to lock the kiosk 720 into running a promotion or contest at selected times.

It should further be understood that a patron may use his or her cell phone or PDA to play a game through the kiosk 720. Furthermore, games could be made available as part of a promotion at a given establishment or as a promotion and competition among several establishments.

Promotional Mode

In a further embodiment, one or more people such as the owner or someone associated with the ownership of the establishment at which a kiosk 720 is located, e.g., the ABC Bar and Lounge, may be granted access or otherwise permitted to operate the kiosk 720 in a promotional mode. In this embodiment, a promotional or access code is granted to such a user, which if entered into the kiosk 720, provides the user with “free” use of the kiosk 720. Such an access code may also be used to perform other actions, such as selecting winners for various contests or promotions, through the kiosk 720.

In a preferred embodiment, the user preferably selects the Promotions button 1206 (FIG. 12) from the top-level screen 1200. As described above, the contest/promotion component 1118 of the kiosk application software 1102 may respond by causing a series of promotion or contest buttons to be displayed on the touch screen 912. The user preferably touches one of these buttons and is presented with the contestant entry screen 1400 (FIG. 14) described above. In the name field 1402, the owner preferably enters the promotional or access code that was supplied to him or her, e.g., by the system administrator. The contest/promotion component 1118 confirms that a valid access code has been entered by comparing it to a database of access codes and, if so, causes a station administrative console to be displayed on the touch screen 912.

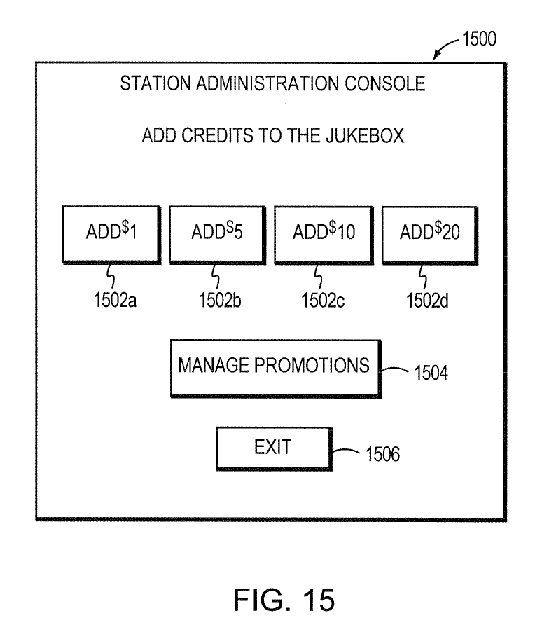

FIG. 15 is a highly schematic illustration of a preferred station administrative console display 1500. The console display 1500 preferably includes one or more juke box credit buttons, such as buttons 1502a-d that, if pressed, cause credits, e.g., in dollar increments, to be added to the juke box mode of the kiosk 720. By adding such credits, the user obtains “free” use of the kiosk 720, and may select songs and/or playlists to be played. The user may alternatively have a disc jockey (DJ) select and play songs through the kiosk 720 after placing the kiosk in the promotional mode. The user or DJ may also use the microphone 920 to make announcements to the customers or patrons of the establishment. The user may also add credits to the kiosk so as to allow the patrons or customers to operate the kiosk 720 in the juke box mode without having to pay their own money.

It should be understood that credits may be added for use in running the kiosk 720 in karaoke or game mode, among other operational modes.

The console display 1500 further includes a manage promotions button 1504, which may be used by the owner to manage the promotions at the kiosk 720, and an exit button 1506 for returning to the top-level menu 1200. Upon pressing the manage promotions button 1504, a first promotion management screen is preferably displayed on touch screen 912.

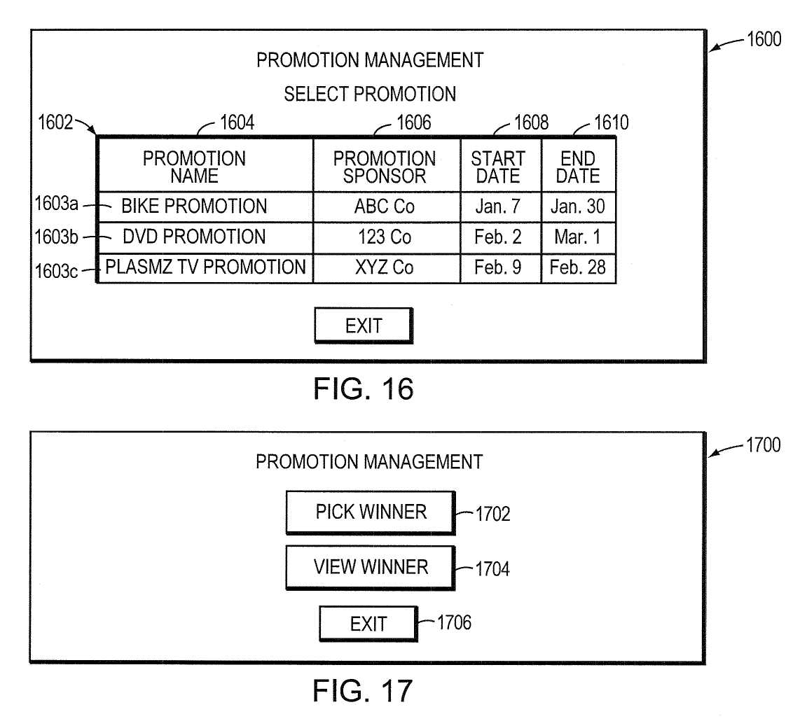

FIG. 16 is a highly schematic illustration of a preferred first promotion management display 1600. The promotion management display 1600 preferably includes a list 1602 of the promotions or contests at the kiosk 720. The list 1602 may include closed, open and future promotions or just the open promotions or contests. The list 1602 may be organized into rows, such as rows 1603a-c, each displaying information regarding a particular promotion or contest. Each row 1603, moreover, may have a series of fields or cells for displaying corresponding information for each promotion, such as a Promotion Name field 1604 in which the name of the promotion is displayed, a Promotion Sponsor field 1606 in which the name of the sponsor is displayed, a Start date field 1608 in which the date on which the promotion opened is displayed, and an End Data field 1610 in which the date on which the promotion closed is displayed. In response to the user selecting one of the promotions from the list 1602, e.g., by pressing it, a second promotion management screen is presented to the user.

FIG. 17 is a highly schematic illustration of a preferred second promotion management display 1700, which includes a Pick Winner button 1702, a View Winner button 1704, and an Exit button 1706 that causes the display to return to the top-level menu 1200. If the user presses the Pick Winner button 1702, the contest/promotion component 1118 of the kiosk application software 1102 preferably runs a script or program, such as a random generator, to select one or more winners, depending on the particular contest or promotion, from the list of people who entered the contest. The touch screen 912 preferably presents the name and contact information of the selected winner. The user may then accept the selected winner. If the selected winner is not a valid contestant, e.g., he or she is an employee of the establishment, etc., the user may invalidate such a contestant, and cause a new winner to be selected. As described above, the winner may be contacted by email, text message, etc., and his or her name may be displayed on the second video display 904b.

By pressing the View Winner button 1704, the owner may review the winner(s) selected for the previously identified promotion or contest. Specifically, the contest/promotion component 1118 may cause the name and contact information for the winner of the identified promotion or contest to be displayed on screen 912.

It should be understood that others besides someone associated with the owner of the establishment may be provided with a promotional or access code. For example, a supplier of goods to the establishment, such as a food and/or beverage supplier, may be given a promotional or access code to operate the kiosk 720 for “free”, e.g., as part of a promotion. In a further embodiment, the supplier may give one or more such codes to the customers or patrons of an establishment so that they may operate the kiosk 720 for “free” for some period of time, to play some number of songs through the juke box mode, to play some number of games through the game mode, etc. A supplier could also award an access code as a prize for a particular contest or promotion.

It should be understood that a promotional or access code may have limited rights, e.g., only to operate the kiosk 720 in certain modes, such as jukebox and karaoke but not game, and/or for a limited amount of time.

Those skilled in the art will recognize that, rather than enter the promotional or access code in the name field 1402, a promotional or administrator button (not shown) may be added to the top-level screen 1200 or to another screen. By pressing this button, the kiosk application software 1102 may cause a login screen to be presented on the touch screen 912. The login screen may include fields for receiving a promotional or access code.

In addition, a kiosk 720 may be operated to play a video program, such as a TV show or a movie. For example, a video program may be downloaded to a kiosk 720 as described above, and scheduled for playback at a selected time. When the selected time occurs, the kiosk 720 plays the video program, e.g., through the second video display 904b and the sound system. The video program may be played with or without advertisements. The owner of an establishment may promote his or her place of business by advertising the playing of one or more video programs at selected times, e.g., Wednesdays at 7:30 p.m. In addition, the playing of a video program could be combined with a contest or promotion. For example, a video program, such as a movie, could be played through a kiosk 720. At its conclusion, a trivia contest about the video program could be run for those who watched the video program. Alternatively or additionally, an enter-to-win contest could be conducted involving the video program. As described herein, patrons or customers could enter the contest and/or promotion through the kiosk 720 and/or through a web site.

Training Mode

In a further embodiment of the present invention, a kiosk 720 may be operated in a training mode. Specifically, the kiosk 720 may be used to train the employees of the establishment in which it is located. For example, a training video may be created, and sent to a kiosk 720 by the management server 710 in the manner described above for other content. The training video may be scheduled for playback during a time set-aside for employee training. At the selected time, the training component 1122 at the kiosk 720 accesses and plays the training video through either or both of the video displays 904 and the sound system 906. At the end of the training video, the training component 1122 may be further configured to present a test on the touch screen 912 that must be taken by each of the employees who attended the training session. Each employee may identify himself or herself to the kiosk 720, e.g., by swiping a driver's license or credit card, or by entering his or her name, and take the test presented on the touch screen 912. The training component 1122 may score each employee, and display the results and/or a pass/fail indication. The test results may also be stored at the kiosk 1114 and/or sent to the management server 710 for storage by the system 700.

In a similar manner, one or more of the kiosks 720 may be used to notify employees of information concerning the establishment. For example, the kiosk 720 may be configured with daily food and/or beverage specials being offered at the establishment. As each employee arrives at the establishment for work, he or she may operate the kiosk 720 so as to review the food and/or beverage specials for that day. Each employee may be required to identify himself or herself to the kiosk 720 as confirmation that he or she reviewed the information, e.g., regarding the day's specials.

Loyalty Card Program

In a further embodiment, customers or patrons of an establishment at which a kiosk 720 is located may be provided with loyalty cards. The loyalty cards may be provided by the administrator of the system 700, by the owner of the establishment at which the kiosk 720 is located, by a supplier goods or services to the establishment, such as a beverage company, by a content provider, such as a record label or movie studio, etc. Credits may be added to a patron's loyalty card in response to various actions. For example, credits may be added when a patron makes purchases at the establishment at which the kiosk 720 is located, such as the purchase of food and beverages. Credits may be added to the patron's loyalty card when he or she enters a promotion or contest through the kiosk 720. When a predetermined number of credits have been added to a loyalty card, the patron may “spend” those credits to operate the kiosk 720, e.g., in juke box, karaoke or game modes. Alternatively, the patron may “spend” the credits to purchase content, such as music or videos, or promotional items, such as t-shirts, hats, etc. from or through the kiosk 720.

Those skilled in the art will recognize that the system 700 may make other uses of such loyalty cards. For example, the loyalty cards may be recognized at various retail locations to obtain discounts or other benefits.

Data Capture

In the illustrative embodiment, the kiosk terminal 902, in addition to its other functions and modes of operation, gathers information and intelligence, such as marketing intelligence, through its operation. More specifically, the local data capture component 1114 is preferably configured to capture the manner in which the kiosk 720 is used and run. That is, the local data capture component 1114 records what songs are selected by patrons for play-back through the juke box mode as well as how often and when those songs are played. It also records what songs are selected for karaoke performances, and what games are played. The local data capture component 1114 may also record what television stations and/or programs are selected for playing on the first video display unit 904a. The local data capture component 1114 also tracks which promotions or contests are accessed and entered by patrons.

In addition, the kiosk terminal 902 preferably gathers marketing or other information through the running of promotions or contests. More specifically, in addition to requesting information identifying the patron who is entering the contest, the touch screen 912 at the kiosk terminal 902 may additionally request other information, such as age, sex, home zip code, purchasing preferences, such as food or beverage choices, of the patron entering the contest. Similarly, the touch screen 912 may have the patron fill-out a questionnaire or survey as part of a promotion or contest.

This information is initially stored by the local data capture component 1114 at the kiosk 720, e.g., at the memory unit 1018. It is then transferred to the master data collector 806 at the management server 710. The transfer may be scheduled to happen every morning or at some other recurring period, e.g., every other day, weekly, etc. The master data collector 806 receives data from all of the kiosks 720 and stores this data. It may be stored at the management server 710 itself and/or at the web server farm 714.

Thereafter, the system administrator can access, search and review this data. Specifically, using the report generator facility 807, the system administrator can configure and run reports on the data. For example, the system administrator can determine the top ten songs at each of the kiosks 720, the top ten promotions or advertisements, the buying habits or trends of the patrons at the location where the particular kiosk 720 is located, the demographics, e.g., age and gender, of the patrons where the kiosk 720 is located, etc. By examining this data, the system administrator can determine the effectiveness of different advertisements, promotions and contests. In addition, the popularity of music and games can be determined. The system administrator can then use this data to sell and/or price advertising and promotions, suggest times for running advertisements or promotions, etc. For example, the system administrator can suggest at what kiosks, e.g., kiosks 720b and 720e, a given advertisement and/or promotion should be run, and at what times for the advertisement and/or promotion to be most successful. Such a determination can be made based on the data captured at these two kiosks 720b and 720e, which might reveal when patrons of a particular age, gender, buying habits and interest, are most likely to be at the establishment.

It should be understood that in addition to installing kiosks at places of public accommodation, such as hospitality locations, e.g., bars, lounges, hotels, restaurants, retail locations, e.g., drugstores, furniture stores, banks, malls, etc., museums, theatres, travel points, e.g., airports, train stations, etc., and other locations, such as convention centers, as described in the illustrative embodiment herein, kiosks, may also be installed in other locations, such as private establishments, such as private clubs, etc.

The programming entity 808 of the management server 710 is preferably used to update and/or change the kiosk application software 1102. For example, if a new version of the kiosk application software 1102 or the operating system 1104 is available, the programming entity 808 may load it onto the kiosks 720. A new version of the kiosk application software 1102 might provide additional features, such as improved audio or promotion interface screens, etc.

Social Network

In a further embodiment of the present invention, system 700 supports the creation and the operation of a web-based social network among the patrons and customers of the locations at which the kiosks 720 are located and/or the owners of the establishments in which the kiosks 720 are located. Customers and patrons can create profiles of themselves, and the system administrator and/or people associated with the establishments at which the kiosks 720 are located can create profiles of those establishments. The domain address for the social network may be displayed periodically on the second video display 904b and/or the touch screen 912 with an invitation to join the social network. In addition, the domain address may be sent to those patrons or customers who have entered their name and contact information, such as an email address or cell phone number, e.g., by entering one of the contests or promotions. The social network web site of system 700 preferably maintains a series of databases containing information of interest to the members of the social network, such as a database of patrons and customers who have registered with the site, a database of the establishments at which kiosks are located, a database of entertainment and social venues, etc.

In the illustrated embodiment, one or more of the servers 734 of the web server farm 714 host one or more web sites supporting the social network. Customers and patrons can access this web site through their PCs, such as PC 740, or their cell phones 720, among other devices. The web site of the social network preferably includes a main window through which the customers and patrons access the social network.

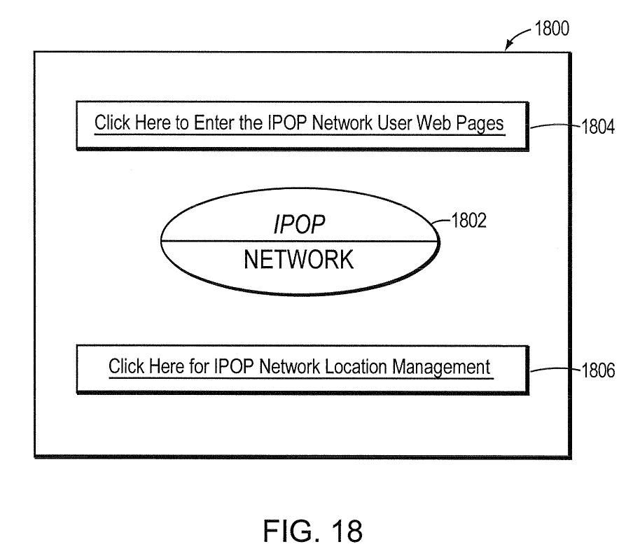

FIG. 18 is a highly schematic illustration of a preferred entry web page 1800 of the social network. The entry web page 1800 may include a logo, such as logo 1802 identifying the social network, e.g., the “IPOP NETWORK”, a first hyperlink 1804 for entering the social network, and a second hyperlink 1806 for use by someone associated with the ownership of an establishment to manage the establishment's profile on the social network. By activating, e.g., clicking, the social network entry hyperlink 1804 of the entry web page 1800, a login web page is preferably displayed on the patron's or customer's computer.

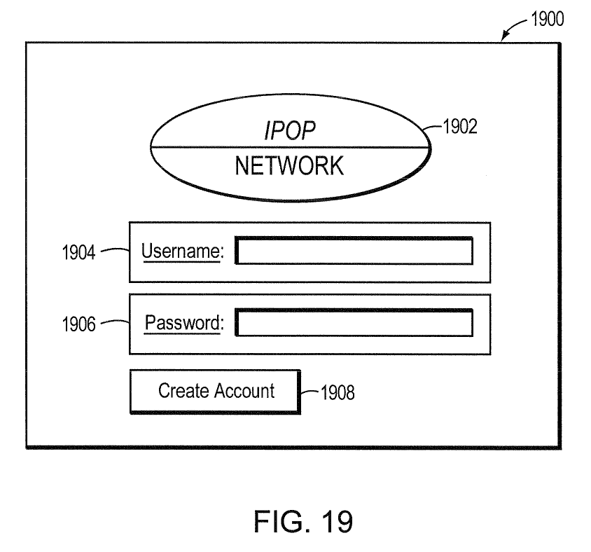

FIG. 19 is a highly schematic illustration of a preferred login web page 1900, which again may include a logo identifying the social network 1902, a username entry field 1904, a password entry field 1906, and a create account hyperlink 1908. A first-time visitor preferably uses the create account hyperlink 1908 to register with the social network and create a unique user name and password. Thereafter, the visitor preferably enters his or her user name and password in fields 1904 and 1906 of login web page 1900. Upon entering a valid user name and password, a main page of the social network is preferably displayed to the visitor.

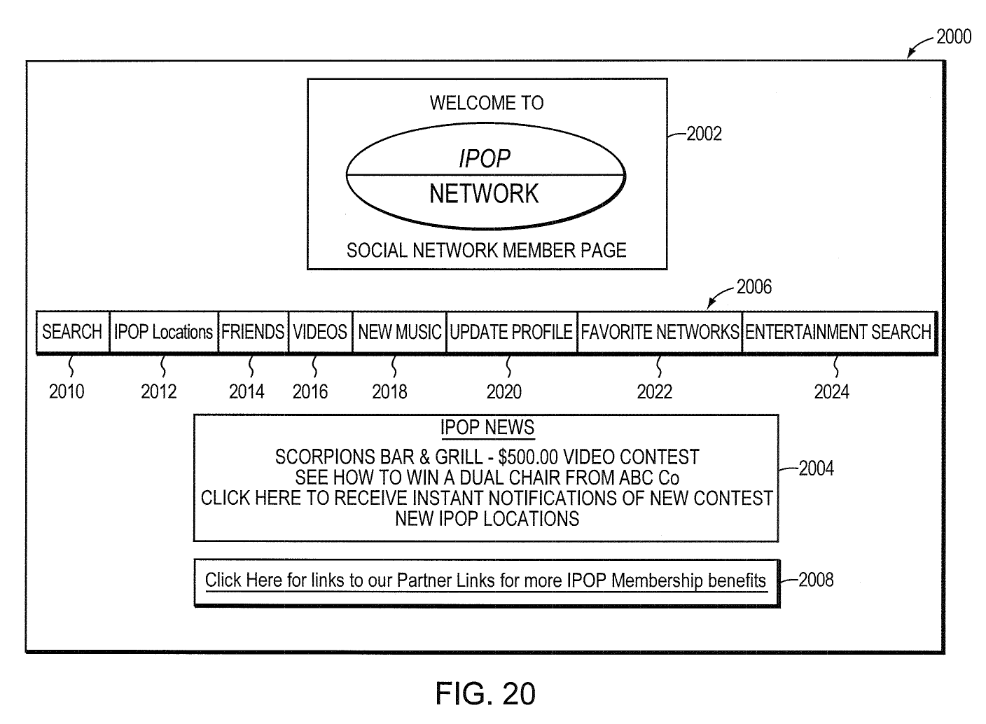

FIG. 20 is a highly schematic illustration of a preferred main page 2000 of the web-based social network. The main web page 2000 may include a welcome banner 2002, a news panel 2004, and a set of hyperlinks 2006 for engaging in the social network. To the extent the social network has one or more partners, such as advertisers, entities running promotions, etc., a partner hyperlink 2008 that links to web pages containing information about those partners may also be provided on the main web page 2000. The set of hyperlinks 2006 may include a search link 2010, a locations link 2012, a friends link 2014, a videos link 2016, a new music link 2018, an update profile link 2020, a favorite networks link 2022, and an entertainment search link 2024.

Those skilled in the relevant art will recognize that other links may be provided, such as a promotions/contests link that may be used to search for or display the promotions/contests being run either on the social network and/or at one or more of the establishments at which a kiosk 720 is located, etc.

To create a profile, a visitor preferably activates the update profile link 2020, which links to a profile page (not shown). The profile page allows the visitor to enter information about himself or herself, such as name, email address, cell phone number, school or college, favorite establishments, music preferences, movie preferences, television preferences, hobbies, a photo, etc. In the illustrative embodiment, the visitor can also create music and/or video playlists and/or upload them from other applications, such as the iTunes music program from Apple Inc. of Cupertino, Calif.

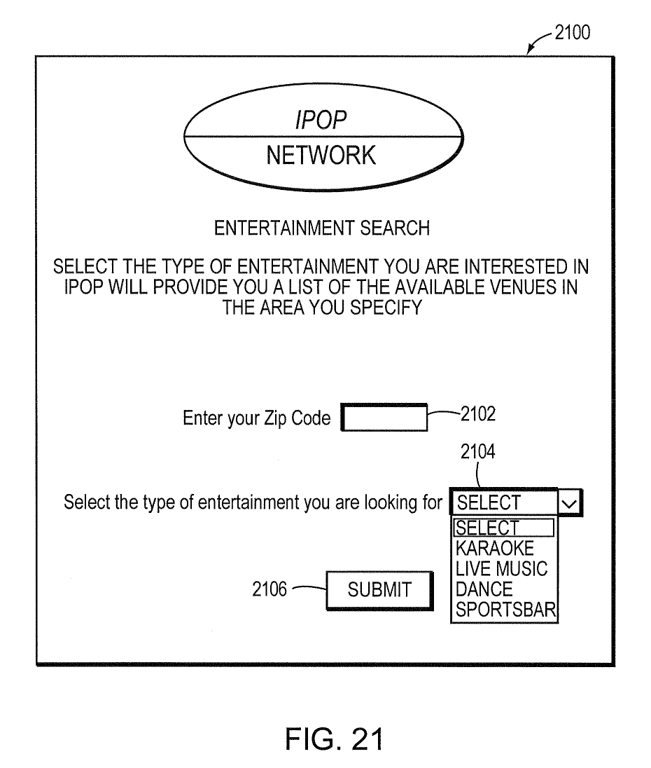

By selecting the entertainment search link 2024, the visitor is preferably taken to an entertainment search page. FIG. 21 is a highly schematic illustration of a preferred entertainment search page 2100. The entertainment search page 2100 preferably has a series of fields in which the visitor may enter information in order to find a desired entertainment venue near the visitor. For example, the entertainment search page 2100 preferably includes a zip code field 2102, in which the visitor may enter his or her zip code, e.g., 03054. Alternatively or additionally, the entertainment search page 2100 may have an address field into which the visitor may enter an address, e.g., city and state. The entertainment search page 2100 may also include a drop-down menu 2104 from which the visitor can select a type of entertainment on which to search, such as karaoke, live music, dance music, sports bar, etc. The entertainment search page 2100 may also have a submit 2106 button, which causes the web server hosting the social network web site to search its database of venues for those venues that satisfy the specified criteria, e.g., karaoke close to zip code 03054. In the preferred embodiment, the venues that satisfy the specified criteria and are within a visitor-selected or pre-programmed range of the entered zip code or address are preferably displayed on a search results page. In this way, a visitor can easily find nearby venues that are of interest to him or her.

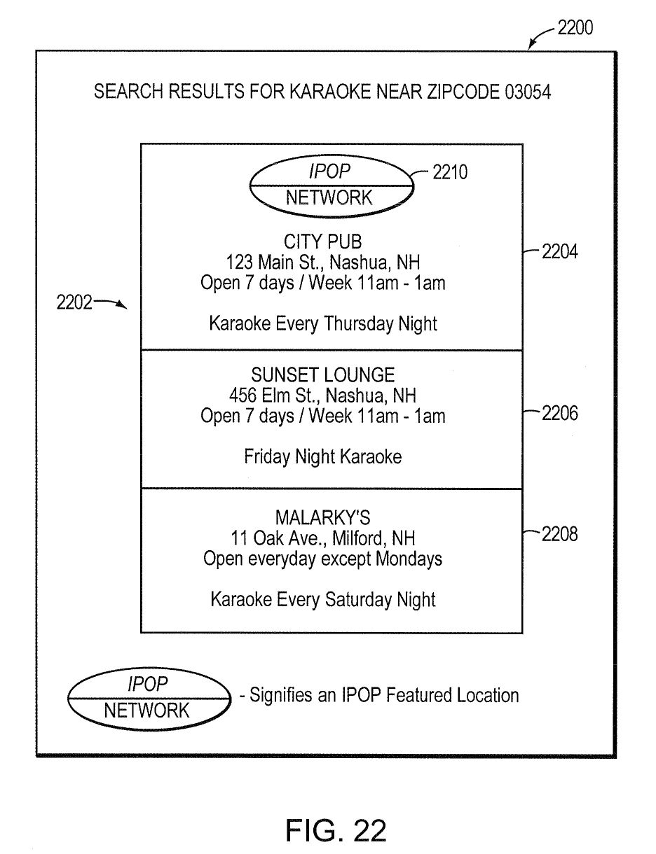

FIG. 22 is a highly schematic illustration of a search results web page 2200. The search results web page 2200 includes a panel or area 2202 that displays those venues satisfying the search criteria. Information regarding each such venue, such as name, location, hours, and when the searched-for entertainment, e.g., karaoke, is offered, may be provided in separate sub-areas 2204-208. Those venues, such as the venue listed in sub-area 2204, that have a kiosk 720 installed may be ranked higher than the others and/or they may be specially marked or displayed, such as with a marker or logo 2210.

Returning to news panel 2004 (FIG. 20) of main page 2000, each of the displayed news items may be a hyperlink that links to a web page containing further details of the news item headlined in news panel 2004. For example, by selecting the “See how to win a Dual Chair from ABC Co.” in panel 2004, a contest page is preferably displayed.

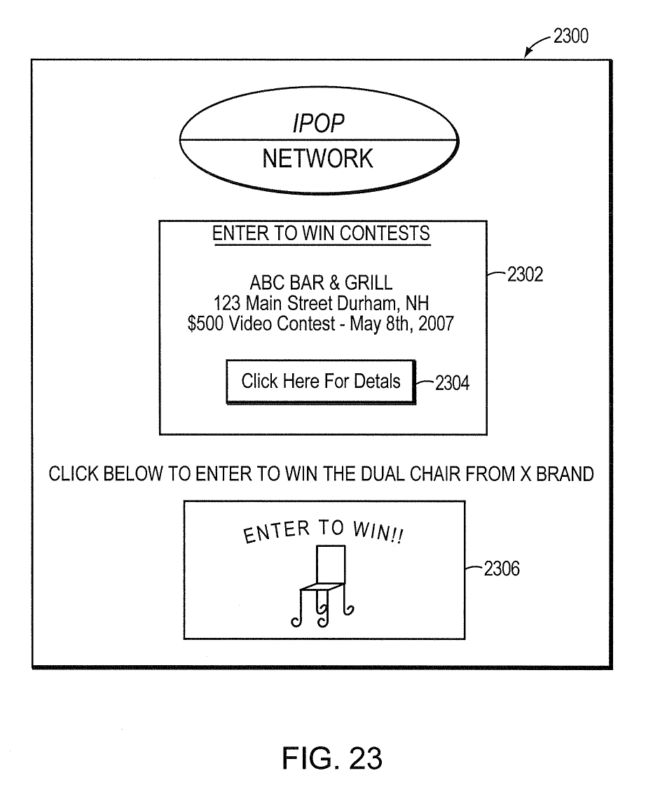

FIG. 23 is a highly schematic illustration of a preferred contest web page 2300 of the social network. Contest page 2300 preferably includes a detail area 2302 containing details of the particular contest or promotion, such as the establishment from which the contest or promotion is being run. The detail area 2302 may include a link, such as link 2304, which if selected causes even further details of the contest or promotion to be displayed. The contest web page 2300 also includes an entry link 2306, which can be used to enter the contest. By selecting the entry link 2306, a contest entry page (not shown) is preferably displayed to the visitor through which he or she may enter the contest or promotion. The visitor may enter the contest by submitting his or her name, email address and/or cell phone number or other contact information, and in a preferred embodiment other information.

In the illustrative embodiment, only registered visitors to the social network web site are permitted to enter contests or promotions. It should be understood that certain contests or promotions may be made available only through the social network web site, others may be available both through the social network web site and through the kiosks 720 as described above, while still others may be available only through the kiosks 720.

Returning to the entry web page 1800 (FIG. 18) of the social network, a person associated with the ownership of an establishment at which a kiosk 720 is located can also access the social network. In particular, in response to an owner selecting the second hyperlink 1806, an owner login screen is preferably displayed.

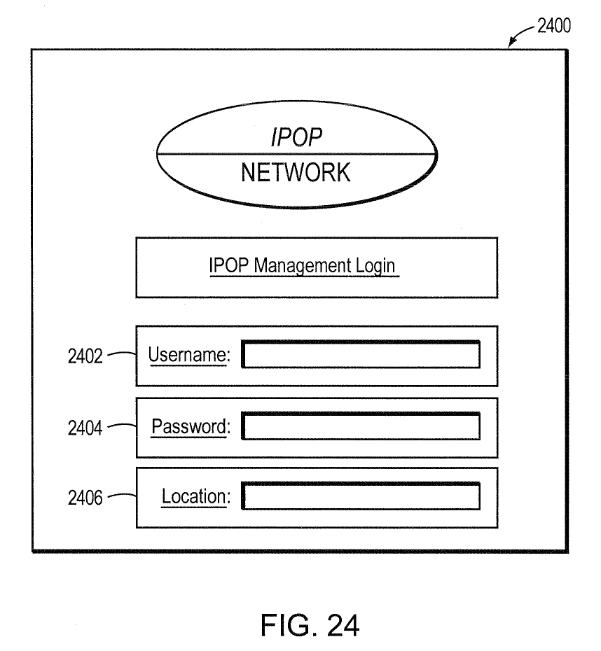

FIG. 24 is a highly schematic illustration of a preferred owner login screen 2400. The owner login screen 2400 preferably includes a username field 2402 for receiving a user name from the owner, a password field 2404 for receiving a password, and, to the extent the owner may have more than one establishment at which a kiosk 720 is located, the login screen 2400 may also have a location field 2406 for receiving the name, address or other identifying information of a particular establishment. An owner may register with the administrator of system 700 to establish a username and password. Upon entering a valid user name, password and, if necessary, location, a location management page is preferably displayed to the owner.

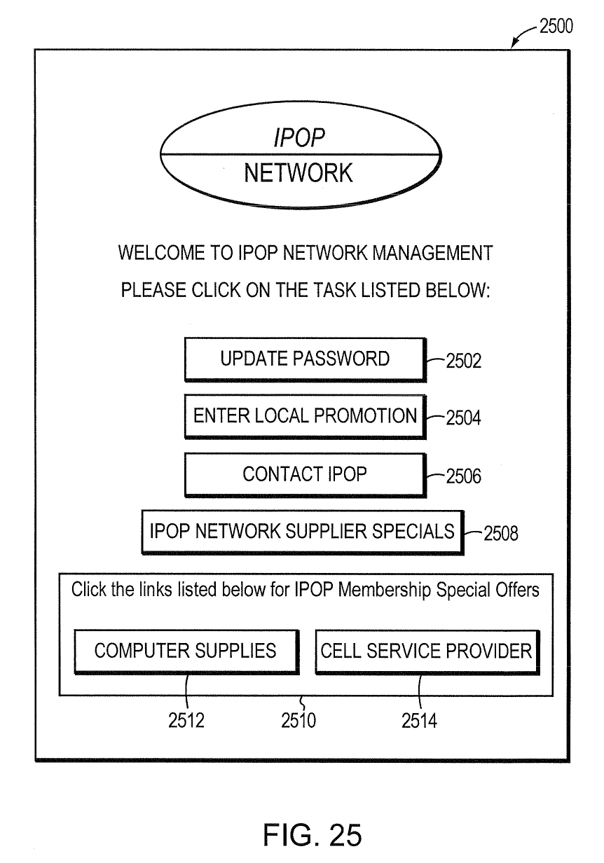

FIG. 25 is a highly schematic illustration of a preferred location management page 2500. The location management page 2500 preferably includes a number of links for performing various actions. For example, the page 2500 preferably includes an update password link 2502 which can be selected to display a web page (not shown) for changing the owner's password. The page 2500 also includes an Enter Local Promotion link 2504. If selected, a promotions web page (not shown) is preferably displayed. This page preferably contains fields for displaying information regarding the promotions or contests at the corresponding establishment. In a preferred embodiment, the owner may also create new promotions or contests through this promotions web page. The page 2500 further includes a contact link 2506, which the owner can use to contact the administrator of the social network web site and or system 700. In addition, the page 2500 has a supplier specials link 2508.

In a preferred embodiment, based on the purchasing power of the members of the social network and/or the owners of the various establishments, the administrator of the system 700 and/or the administrator of the social network preferably enters into agreements with suppliers to obtain discounts on various goods or services. Owners of the establishments can obtain information about these discounts by selecting the supplier specials link 2508. Selecting this link 2508 preferably causes a specials page (not shown) to be displayed that contains detailed information about the discounts that are available. The page 2500 may also include a membership specials area 2510 that highlights certain discounts or specials that are available to the owners of the establishments. Specials area 2510 may include a first link 2512, which if selected provides information for obtaining a discount, for example, on computer supplies, and a second link 2514, which if selected provides information for obtaining a discount, for example, on cell phone service.

It should be understood a member may need to use his or her loyalty card, described above, in order to receive some or all of the discounts or other benefits. Further, one set of discounts or benefits may be available to the customers and patrons of an establishment, while another set of discounts and benefits may be available to the owners of the establishments.

Returning to the main page 2000 (FIG. 20) of the social network, a visitor can select any of the set of hyperlinks 2006 to participate in the social network. More specifically, by selecting the search link 2010, a main search page (not shown) is preferably displayed. A visitor may use the main search page to search at least some of the information maintained by social network web site. In particular, the visitor can use the main search page to search a patron database to find other patrons or visitors that share the same interests as the visitor, such as karaoke, a particular sports team, etc. Selection of the locations link 2012 preferably causes a location search page (not shown) to be displayed. The visitor can operate the location search page to search for establishments at which kiosks 720 have been installed. In the preferred embodiment, searches may be run by location, e.g., city or town, type of establishment, type of contests or promotions being offered, etc.

Selection of the friends link 2014 preferably causes a friend search page (not shown) to be displayed. The visitor can operate the friend search page to search for other members of the social network. In the preferred embodiment, searches may be run based on name, address, interests or hobbies, establishments frequented, etc.

Selecting the videos link 2016 preferably causes a web page (not shown) to be displayed that contains a list (and/or allows a search to be run) of videos available for viewing and/or purchase from the social network. These videos may be professionally created music, TV or movie based videos, among others, and/or they may be amateur videos created by one or more members of the social network. Similarly, selection of the new music link 2018 preferably causes a web page (not shown) to be displayed that contains a list (and/or allows a search to be run) of music available for playing and/or purchase from the social network. The music may likewise be professionally created or created by one or more members of the social network. Selecting the favorite networks link 2022 preferably causes a web page (not shown) that lists favorite web sites of either the visitor or of other members of the social network, such as the most popular web sites.

In accordance with the preferred embodiment, members of the social network can also participate in the social network through the kiosks 720 located in the establishments. More specifically, in a preferred embodiment, a customer or patron who is also a member of the social network can log into the web site social network through the kiosk 720. For example, the customer may swipe his or her driver's license or other identification through the card reader 914. In response, the kiosk application software 1102 may cause the login screen 1900 to be displayed on the touch screen 912. The patron may then enter his or her user name and password, created for the social network, and thus access the social network web site through the kiosk 720. Additionally or alternatively, a social network button may be added to the top-level screen 1200 to enter the social network. In this way, the patron can access his or her play list from his or her profile, and operate the kiosk 720 in jukebox mode such that the kiosk plays the patron's play list.

In a further embodiment, a member of the social network can access his or her profile by operating his or her cell phone, while at an establishment with a kiosk 720, e.g., through the telephony gateway 712. For example, the member can access his or her profile and cause a play list to be sent to the kiosk 720 for playback.

Those skilled in the art will recognize that the system 700 can support other such uses.

As shown, the social network of the present invention is organized, at least in part, around the establishments that have kiosks 720. Accordingly, members of the social network can search for and find people who frequent the same establishments, share similar interests in music, movies, sporting teams and events, etc.

It should be understood that the web pages supporting the social network may include additional information, such as advertisements, links to other web sites, such as the suppliers of products or services to the establishments at which the kiosks are located, such as food and beverage suppliers, etc.

Those skilled in the art will recognize that various applications, such as web-building applications, database applications, network security applications, etc. may be used to build the social network web site. Suitable sites for use as models in the organization and the display of features of the web-based social network of the present invention include Myspace and Facebook, among others.

Wireless Network Access

In a further embodiment, one or more of the kiosks 720 may be configured with a wireless transceiver, such as a wireless router and/or access point. Suitable wireless devices are commercially available from the LinkSys division of Cisco Systems, Inc. of San Jose, Calif., and from Apple Inc. of Cupertino, Calif., among others. Each kiosk 720 having a wireless transceiver may also have a high-speed network connection, such as a DSL or cable line, that is separate from the private network 722 connection. Accordingly, each kiosk 720 with a wireless transceiver can provide patrons and customers having wireless devices, such as laptop computers and PDAs, with access to the Internet. Patrons or customers may be required to register and/or pay a fee for accessing the Internet through the kiosk's wireless transceiver.

The foregoing has been a detailed description of illustrative embodiments of the invention. Various modifications and additions can be made without departing from the spirit and scope of the invention. Accordingly, this description is meant to be taken only by way of example and not to otherwise limit the scope of the invention.

What is claimed is:

1. A system comprising:
a plurality of kiosks, wherein each kiosk is disposed in a different location, and includes at least one video display;
a management server having a master scheduler and a content manager; and
a communications medium coupled to the plurality of kiosks and the management server, the communication medium configured to provide communication between the management server and the plurality of kiosks, wherein
the content manager is configured to receive content and to supply the received content to at least a selected one of the plurality of kiosks,
the master scheduler is configured to direct the selected one of the plurality of kiosks to play the content at selected time, and
the selected one of the plurality of kiosks is configured to play the content at about the selected time on the at least one video display.

2. The system of claim 1 further comprising:
a server farm coupled to the communications medium, wherein
the server farm is configured to store the content, and
the content manager of the management server is configured to access the content from the server farm and supply it to the kiosks.

3. The system of claim 1 wherein the content includes one or more of: an advertisement, a promotion, and a song.

4. The system of claim 1 wherein the communications medium is a private network.

5. The system of claim 1 wherein each kiosk further includes:
a touch screen; and
a memory unit configured with a plurality of songs, wherein
each kiosk is configured to present a display on the touch screen that is controlled by a patron to cause a selected one of the plurality of songs to be played back on a sound system.

6. The system of claim 5 wherein
each kiosk further includes a money acceptor, and
each kiosk is configured to require a patron to enter money before allowing the selected one of the plurality of songs to be played back on the sound system.

7. The system of claim 1 wherein each kiosk further includes:
a touch screen; and
a memory unit configured with at least one contest, wherein
each kiosk is configured to present a display on the touch screen that is controlled by a patron to enter the at least one contest.

8. The system of claim 7 wherein the display on the touch screen obtains information from the patron entering the at least one contest.

9. The system of claim 8 wherein the kiosk is configured to send the information obtained from the patron to the management server.
